(19) United States
(12) Patent Application Publication
(10) Pub. No.: US 2024/0205269 A1
(43) Pub. Date: Jun. 20, 2024

(54) SYSTEMS, APPARATUS, ARTICLES OF MANUFACTURE, AND METHODS TO IMPROVE DEVICE CONNECTIVITY

(71) Applicant: Intel Corporation, Santa Clara, CA (US)

(72) Inventors: Arvind Kumar, Beaverton, OR (US); Duncan Glendinning, Chandler, AZ (US); Chia-Hung S. Kuo, Folsom, CA (US); Anand Rangarajan, Portland, OR (US); Gautam Singh, Morrisville, NC (US)

(21) Appl. No.: 18/069,098

(22) Filed: Dec. 20, 2022

(51) Int. Cl. H04L 65/1069; H04L 67/02

(52) U.S. Cl. CPC H04L 65/1069; H04L 67/02; G06F 9/4401

(57) ABSTRACT

Methods, apparatus, systems, and articles of manufacture are disclosed to improve device connectivity. An example system includes an electronic device to broadcast a message including a uniform resource indicator (URI), the URI corresponding to the electronic device, and an endpoint device to, after obtaining the message, launch a user interface to display a request for authorization to connect to the electronic device, after obtaining the authorization, retrieve an instance of a container based on the URI, and execute a service with the container based on data obtained from the electronic device.

### FIELD OF THE DISCLOSURE

This disclosure relates generally to device connectivity and, more particularly, to systems, apparatus, articles of manufacture, and methods to improve device connectivity.

### BACKGROUND

Connecting to a wide range of electronic peripherals and devices is becoming increasingly complex as users must become familiar with the growing number of corresponding peripheral and device vendors and their electronic ecosystems. Typically, connecting an electronic device to another electronic device requires multiple steps that yield a frustrating user experience and a fragmented network of peripherals and devices associated with a user.

### BRIEF DESCRIPTION OF THE DRAWINGS

FIG. 1 is an example device connectivity system to implement examples disclosed herein.

FIG. 2 is an implementation of example device configuration agent interface circuitry to implement examples disclosed herein.

FIG. 3 is an implementation of example device configuration agent circuitry to implement examples disclosed herein.

FIG. 4 is an example device connectivity system architecture to implement examples disclosed herein.

FIG. 5 is an implementation of an example endpoint device to implement examples disclosed herein.

FIG. 6 is an example implementation of a uniform resource indicator format and a corresponding quick response code.

FIG. 7 is an example implementation of data that may be obtained using examples disclosed herein.

FIG. 8 is another example implementation of data that may be obtained using examples disclosed herein.

FIG. 9 is a flowchart representative of example machine readable instructions and/or example operations that may be executed by example processor circuitry to implement the example device configuration agent interface circuitry of FIG. 2 and/or the example device configuration agent circuitry of FIG. 3 to instantiate a container to execute a service based on data from an electronic device.

FIG. 10 is a flowchart representative of example machine readable instructions and/or example operations that may be executed by example processor circuitry to implement the example device configuration agent interface circuitry of FIG. 2 and/or the example device configuration agent circuitry of FIG. 3 to connect a first electronic device to a second electronic device.

FIG. 11 is a flowchart representative of example machine readable instructions and/or example operations that may be executed by example processor circuitry to implement the example device configuration agent interface circuitry of FIG. 2 and/or the example device configuration agent circuitry of FIG. 3 to connect an electronic device to an endpoint device.

FIG. 12 is a flowchart representative of example machine readable instructions and/or example operations that may be executed by example processor circuitry to implement the example device configuration agent interface circuitry of FIG. 2 and/or the example device configuration agent circuitry of FIG. 3 to execute a workload using a container.

FIG. 13 is a flowchart representative of example machine readable instructions and/or example operations that may be executed by example processor circuitry to implement the example device configuration agent interface circuitry of FIG. 2 and/or the example device configuration agent circuitry of FIG. 3 to discover configuration agent(s) on a network.

FIG. 14 is a flowchart representative of example machine readable instructions and/or example operations that may be executed by example processor circuitry to implement the example device configuration agent interface circuitry of FIG. 2 and/or the example device configuration agent circuitry of FIG. 3 to cause operation(s) to occur based on at least one of recommendation(s) or output(s) from a machine-learning model.

FIG. 15 is a flowchart representative of example machine readable instructions and/or example operations that may be executed by example processor circuitry to implement an example cloud service of FIG. 1 for device connectivity registration.

FIG. 16 is a block diagram of an example processing platform including processor circuitry structured to execute the example machine readable instructions and/or the example operations of FIGS. 9, 10, 11, 12, 13, 14, and/or 15 to implement the example device configuration agent interface circuitry of FIG. 2.

FIG. 17 is a block diagram of an example processing platform including processor circuitry structured to execute the example machine readable instructions and/or the example operations of FIGS. 9, 10, 11, 12, 13, 14, and/or 15 to implement the example device configuration agent circuitry of FIG. 3.

FIG. 18 is a block diagram of an example implementation of the processor circuitry of FIGS. 16 and/or 17.

FIG. 19 is a block diagram of another example implementation of the processor circuitry of FIGS. 16 and/or 17.

FIG. 20 is a block diagram of an example software distribution platform (e.g., one or more servers) to distribute software (e.g., software corresponding to the example machine readable instructions of FIGS. 9, 10, 11, 12, 13, 14, and/or 15) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

Connecting a wide range of electronic peripherals and devices (e.g., automation devices, home devices, health peripherals, hardware implemented virtual assistants, etc.) to other electronic devices such as a laptop computer, a tablet computer, a mobile phone, a server, an access point, etc., may include a multi-step process that does not meet user expectations of seamless vertical solution experiences. Failure to meet user expectations for device connectivity may cause degradation of the user experience with such electronic peripherals and devices and ultimately frustrate a user's end goal or purpose. Device connectivity between electronic devices of different device manufacturers and/or vendors may be complex or not feasible if interoperability between the electronic devices is not contemplated by the different device manufacturers/vendors.

Some examples disclosed herein effectuate seamless connectivity experiences (e.g., one-click connectivity experiences, two-click connectivity experiences, etc.) with a wide variety of known and not yet known device types (e.g., peripherals, sensors, health devices, automation controllers, etc.). In some disclosed examples, a seamless connectivity experience can be implemented by a first electronic device detecting and/or discovering a second electronic device to connect to. For example, the seamless connectivity experience can require a small number (e.g., 1, 2, etc.) of clicks, selections, etc. The first electronic device can launch a user interface to present a request for authorization to a user to connect to the second electronic device. After the request for authorization is obtained, the first electronic device can connect to the second electronic device with a seamless connectivity experience (e.g., the initial click of a user from the request for authorization) from the perspective of the user. The first electronic device can carry out and/or execute workloads associated with the second electronic device, which can include obtaining sensor and/or control data from the second electronic device, executing and/or instantiating machine-learning models to generate sensor and/or control recommendations based on the sensor and/or control data, etc., and/or any combination(s) thereof. Although examples disclosed herein are described in conjunction with a one-click seamless connectivity experience, examples disclosed herein may be described in conjunction with a tap of a screen, a push of a button, an audio response, a user gesture, and/or any other user interaction with a device.

Some examples disclosed herein enable electronic devices, such as laptop computers, tablet computers, etc., to implement operating environment agnostic seamless connectivity experiences. For example, a laptop computer as disclosed herein can effectuate a seamless connectivity experience using any type of operating system or environment (e.g., Microsoft® Windows®, Linux®, Google® Chrome OS™, Google® Android™ platform, Apple® macOS®, Apple® iPadOS®, etc.). In some disclosed examples, a first electronic device can be connected and/or communicatively coupled to multiple second electronic devices (and/or vice versa). For example, the first electronic device and one(s) of the second electronic devices can be connected to each other via a mesh network or any other type of peer-to-peer networking architecture or schema. In some disclosed examples, the connections may be facilitated based on proximity and location of the electronic devices and/or user intent (e.g., inferred or provided).

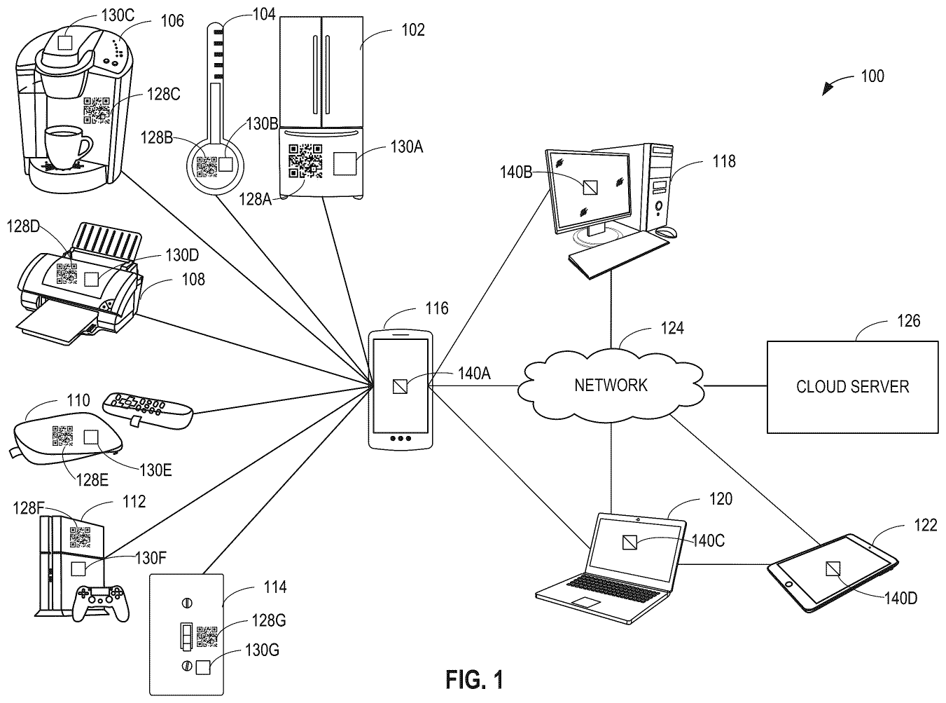

FIG. 1 is an example device connectivity system 100 to implement examples disclosed herein. The device connectivity system 100 of the illustrated example includes example electronic devices 102, 104, 106, 108, 110, 112, 114, a first example endpoint device 116, a second example endpoint device 118, a third example endpoint device 120, a fourth example endpoint device 122, an example network 124, and an example cloud server 126. Further depicted are example codes 128A, 128B, 128C, 128D, 128E, 128F, 128G (collectively referred to as 128 or 128A-F unless otherwise specified herein).

Also depicted are example device configuration agent interfaces 130A, 130B, 130C, 130D, 130E, 130F, 130G (collectively referred to as 130 or 130A-G unless otherwise specified herein). For example, one or more instructions and/or operations executed and/or instantiated by a first one of the device configuration agent interfaces 130A can be executed and/or instantiated by a second one of the device configuration agent interfaces 130B and vice versa.

Additionally depicted in the illustrated example are example device configuration agents 140A, 140B, 140C, 140D (collectively referred to as 140 or 140A-D unless otherwise specified herein). For example, one or more instructions and/or operations executed and/or instantiated by a first one of the device configuration agents 140A can be executed and/or instantiated by a second one of the device configuration agents 140B and vice versa.

In some examples, the device configuration agent interfaces 130A-G can be executed and/or instantiated to facilitate connectivity between electronic devices and/or endpoint devices. For example, the device configuration agent interfaces 130A-G can be executed and/or instantiated to communicate with one(s) of the electronic devices 102, 104, 106, 108, 110, 112, 114 and/or one(s) of the endpoint devices 116, 118, 120, 122 using any communication protocol or standard, such as Bluetooth, Bluetooth Low Energy (BLE), near-field communication (NFC), Wireless Fidelity (Wi-Fi), Wi-Fi direct, Zigbee, Thread, or any other communication protocol or standard.

In some examples, the device configuration agents 140A-D can be executed and/or instantiated to facilitate connectivity between electronic devices and/or endpoint devices. For example, the device configuration agents 140A-D can be executed and/or instantiated to communicate with one(s) of the electronic devices 102, 104, 106, 108, 110, 112, 114 and/or one(s) of the endpoint devices 116, 118, 120, 122 using any communication protocol or standard, such as Bluetooth, BLE, NFC, Wi-Fi, Wi-Fi direct, Zigbee, Thread, or any other communication protocol or standard. In some examples, the device configuration agents 140A-D can establish connection(s) to device(s), such as by obtaining an identifier, such as a uniform resource identifier (URI), from an electronic device and obtaining container(s), service(s), etc., corresponding to the URI to establish the connection(s).

The electronic devices 102, 104, 106, 108, 110, 112, 114 include a first example electronic device 102, a second example electronic device 104, a third example electronic device 106, a fourth example electronic device 108, a fifth example electronic device 110, a sixth example electronic device 112, and a seventh example electronic device 114. The first electronic device 102 is an appliance (e.g., a home appliance, a kitchen appliance, etc.), such as a refrigerator (e.g., a smart refrigerator). The second electronic device 104 is a sensor (e.g., an Internet-of-Things (IoT) sensor), such as a thermometer or thermostat (e.g., a smart thermometer or smart thermostat). The third electronic device 106 is a coffee machine (e.g., a smart coffee machine). The fourth electronic device 108 is a peripheral or peripheral device, such as a printer (e.g., an ink-jet printer, a laser printer, etc.). The fifth electronic device 110 is a streaming media device (e.g., an Apple TV®, a ROKU TV™, etc.) and a corresponding remote control device. The sixth electronic device 112 is a gaming console and a corresponding controller (e.g., a game console controller, a gaming controller, etc.). The seventh electronic device 114 is a switch (e.g., a light switch, a smart light switch, etc.). Additionally or alternatively, the device connectivity system 100 may include any other number and/or type of electronic device or peripheral than depicted in the illustrated example of FIG. 1.

The electronic devices 102, 104, 106, 108, 110, 112, 114 are depicted as being communicatively coupled and/or connected to the first endpoint device 116 for illustrative purposes. Additionally or alternatively, one(s) of the electronic devices 102, 104, 106, 108, 110, 112, 114 may be communicatively coupled and/or connected to any other electronic device and/or endpoint device (e.g., the second endpoint device 118, the third endpoint device 120, etc.) and/or network, such as the network 124.

The electronic devices 102, 104, 106, 108, 110, 112, 114 have and/or are affixed with a code (e.g., a label depicting a code), such as a quick-response (QR) code. For example, the electronic devices 102, 104, 106, 108, 110, 112, 114 are affixed with a respective one of the codes 128A, 128B, 128C, 128D, 128E, 128F, 128G (e.g., the first electronic device 102 is labeled and/or affixed with a first example code 128A, etc.). Additionally or alternatively, one(s) of the electronic devices 102, 104, 106, 108, 110, 112, 114 may be affixed with any other type of code, such as a bar code. Additionally or alternatively, one(s) of the electronic devices 102, 104, 106, 108, 110, 112, 114 may be affixed with any other type of identifier, such as a text, an image, etc., (e.g., that can be read and/or scanned by a sensor). Additionally or alternatively, one(s) of the electronic devices 102, 104, 106, 108, 110, 112, 114 may include and/or be embedded with a radiofrequency identification (RFID) tag or device, a near-field communication (NFC) tag or device, etc., and/or any combination(s) thereof. In some examples, one(s) of the electronic devices 102, 104, 106, 108, 110, 112, 114 can be labeled and/or identified as an Intel® EVO™ device, or an EVO™ device as provided by Intel Corporation of Santa Clara, California.

The electronic devices 102, 104, 106, 108, 110, 112, 114 include, execute, and/or instantiate a respective one of the device configuration agent interfaces 130A, 130B, 130C, 130D, 130E, 130F, 130G (e.g., the first electronic device 102 includes, executes, and/or instantiates the first device configuration agent interface 130A). For example, the device configuration agent interfaces 130A-F can be implemented by hardware alone, or by hardware, software, and/or firmware.

The endpoint devices 116, 118, 120, 122 are physical devices that connect to and/or exchange information with a network (e.g., a computer network, an electronic network, a peer-to-peer (P2P) network, a mesh network, etc.). The endpoint devices 116, 118, 120, 122 include a first example endpoint device 116, a second example endpoint device 118, a third example endpoint device 120, and a fourth example endpoint device 122. The first endpoint device 116 is a handheld device, such as a smartphone (e.g., an Internet-enabled smartphone). The second endpoint device 118 is a desktop computer. The third endpoint device 120 is a laptop computer. The fourth endpoint device 122 is a tablet (e.g., a tablet computer). Additionally or alternatively, the endpoint devices 116, 118, 120, 122 may include any other number and/or type of endpoint devices.

The example network 124 of the illustrated example of FIG. 1 is the Internet. However, the example network 124 may be implemented using any suitable wired and/or wireless network(s) including, for example, one or more data buses, one or more Local Area Networks (LANs), one or more wireless LANs (WLANs), one or more cellular networks, one or more private networks, one or more public networks, etc. The example network 124 enables one(s) of the endpoint devices 116, 118, 120, 122 to be in communication with each other. Additionally or alternatively, one(s) of the endpoint devices 116, 118, 120, 122 may be in communication with each other via a direct connection, which can be implemented by a Bluetooth connection, a BLE connection, an NFC connection, an RFID connection, a Wi-Fi connection, a Wi-Fi direct connection, a Zigbee connection, a Thread connection, or any other P2P connection. The example network 124 enables one(s) of the endpoint devices 116, 118, 120, 122 to be in communication with one(s) of each other and/or the cloud server 126.

The cloud server 126 of the illustrated example can be implemented by a public and/or private cloud services provider. For example, the cloud server 126 can be implemented by one or more servers and/or one or more other computing devices. In some examples, the one or more servers are physical hardware servers (e.g., rack-mount servers, blade servers, etc.). In some examples, the one or more servers are virtualizations of physical hardware servers. In some examples, the one or more servers are a combination of physical hardware server(s) and/or virtualization(s) of the physical hardware server(s).

The endpoint devices 116, 118, 120, 122 include, execute, and/or instantiate a respective one of the device configuration agents 140A, 140B, 140C, 140D (e.g., the first endpoint device 116 includes, executes, and/or instantiates the first device configuration agent 140A). For example, the device configuration agents 140A-D can be implemented by hardware alone, or by hardware, software, and/or firmware.

In example operation, the electronic devices 102, 104, 106, 108, 110, 112, 114 can discover (e.g., electronically discover, communicatively discover, etc.) and/or attempt to discover one(s) of the device configuration agents 140A-D in the device connectivity system 100. For example, the electronic devices 102, 104, 106, 108, 110, 112, 114 can discover one(s) of the device configuration agents 140A-D upon being bootup, started, initialized, and/or powered. In some examples, the electronic devices 102, 104, 106, 108, 110, 112, 114 can discover one(s) of the device configuration agents 140A-D after being triggered and/or invoked via a physical input, such as a button, switch, or other physical activation or actuation. For example, the first electronic device 102 can discover one(s) of the device configuration agents 140A-D after a button, such as a pairing button or ready-to-pair button, on the first electronic device 102 is actuated, pressed, etc., which causes an input signal representative of a ready-to-pair or manual pairing operation. In some examples, during the discovery process, the electronic devices 102, 104, 106, 108, 110, 112, 114 can broadcast and/or transmit identification information such as a URI. For example, the first electronic device 102 can broadcast a URI that corresponds to and/or identifies the first electronic device 102.

After one(s) of the electronic devices 102, 104, 106, 108, 110, 112, 114 discover one(s) of the device configuration agents 140A-D, the discovered one(s) of the device configuration agents 140A-D can generate and/or launch a graphical user interface (GUI), such as a notification window, a device connectivity dashboard, etc. The device configuration agents 140A-D can launch the GUI to display a request for authorization to connect to one(s) of the electronic devices 102, 104, 106, 108, 110, 112, 114. For example, after receiving the URI from the first electronic device 102, the first endpoint device 116 can invoke the first device configuration agent 140A to launch a GUI to include a request for authorization and/or verification to connect to the first electronic device 102. For example, the GUI can display a screen, a notification, etc., depicting “New Device X found on the network—Click here to connect” or the like.

After receiving the authorization (e.g., from a user interacting with an authorize or accept button on the GUI, from a software service that authorizes or accepts the connection, etc.), the first device configuration agent 140A transmits the URI to the cloud server 126. In some examples, the cloud server 126 can identify one or more applications, services, etc., which can be implemented by containers (e.g., software containers, virtual or virtualized containers, etc.) that correspond to the URI based on a data association or mapping of the URI and the one or more applications, services, etc. The cloud server 126 can provide, transmit, and/or output the container(s) to the first device configuration agent 140A (e.g., via the network 124) for execution and/or instantiation. For example, the first device configuration agent 140A, and/or, more generally, the first endpoint device 116, can execute and/or instantiate the container(s) (e.g., execute and/or instantiate the container(s) in a container execution environment) to execute workload(s). In some examples, the workload(s) can include implementing communication protocols, telemetry data collection, sensor data collection, machine-learning workloads, automation or control tasks, etc., and/or any combination(s) thereof. For example, the first device configuration agent 140A, and/or, more generally, the first endpoint device 116, can connect to the first electronic device 102 to facilitate data collection, automation and/or control, etc.

In some examples, the endpoint devices 116, 118, 120, 122 can connect to the electronic devices 102, 104, 106, 108, 110, 112, 114 based on a detection and/or identification of the codes 128A-G. For example, the first endpoint device 116 can capture an image, with a camera or other image sensor, of the first code 128A. In some examples, the first device configuration agent 140A can determine that the first code 128A in the image corresponds to a URI of the first electronic device 102. The first device configuration agent 140A can provide the URI to the cloud server 126 in exchange for container(s) corresponding to the URI, and/or, more generally, communication with the first endpoint device 116. Additionally or alternatively, the first device configuration agent 140A can obtain the URI via sensor data from an RFID tag, an NFC chip or device, etc., included in and/or associated with the first electronic device 102.

In some examples, the first device configuration agent 140A can generate and/or launch a GUI based on the URI captured from the image of the first code 128A. For example, the first device configuration agent 140A can present a request for authorization to connect to the first electronic device 102 via the GUI. In some examples, a user can accept the request for authorization to cause the first device configuration agent 140A to output the URI to the cloud server 126 via the network 124.

In some examples, the first device configuration agent 140A can cause a different device configuration agent, such as the second device configuration agent 140B on the second endpoint device 118 to generate and/or launch the GUI. For example, the first device configuration agent 140A can display and/or launch a first GUI that depicts available one(s) of the endpoint devices 116, 118, 120, 122 to connect to the first electronic device 102. After a selection of one of the available one(s) of the endpoint devices 116, 118, 120, 122, such as the second endpoint device 118, the first device configuration agent 140A can output the URI to the second device configuration agent 140B to cause the second device configuration agent 140B to generate and/or launch a second GUI based on the URI. For example, the second GUI can include a request for authorization to connect to the first electronic device 102. After obtaining the request for authorization, the second device configuration agent 140B, and/or, more generally, the second endpoint device 118, can install container(s) or any other type of software and/or firmware to facilitate a communication connection, link, channel, etc., between the first electronic device 102 and the second endpoint device 118.

The device configuration agent interfaces 130A-G and/or the device configuration agents 140A-D can deliver and/or implement seamless friction-free connectivity user experiences. For example, the device configuration agent interfaces 130A-G and/or the device configuration agents 140A-D can cause a GUI to display a request for device connection authorization to a user and the user can achieve the device connection with limited interaction (e.g., using a single interaction, such as a one-click operation) from the perspective of the user.

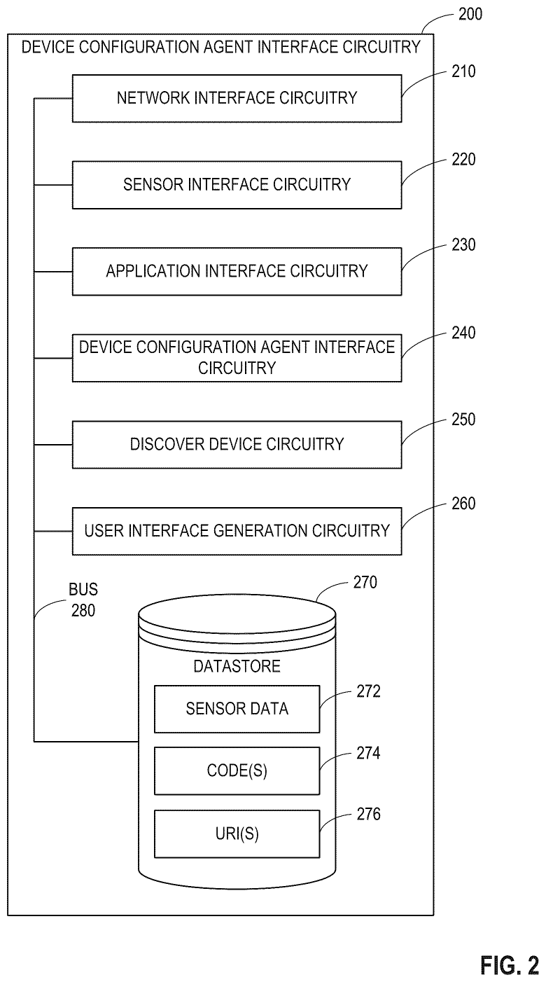

FIG. 2 is a block diagram of an implementation of example device configuration agent interface circuitry 200 to establish connection(s) between device(s) of FIG. 1. In some examples, respective ones of the device configuration agent interfaces 130A-G of FIG. 1 can be implemented by the device configuration agent interface circuitry 200 of FIG. 2. The device configuration agent interface circuitry 200 of FIG. 2 may be instantiated (e.g., creating an instance of, bring into being for any length of time, materialize, implement, etc.) by processor circuitry such as a central processing unit executing instructions. Additionally or alternatively, the device configuration agent interface circuitry 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the device configuration agent interface circuitry 200 of FIG. 2 may, thus, be instantiated at the same or different times. Some or all of the device configuration agent interface circuitry 200 of FIG. 2 may be instantiated, for example, in one or more threads executing concurrently on hardware and/or in series on hardware. Moreover, in some examples, some or all of the device configuration agent interface circuitry 200 of FIG. 2 may be implemented by microprocessor circuitry executing instructions to implement one or more virtual machines and/or containers.

The device configuration agent interface circuitry 200 of FIG. 2 includes example network interface circuitry 210, example sensor interface circuitry 220, example application interface circuitry 230, example device configuration agent interface circuitry 240, example discover device circuitry 250, example user interface generation circuitry 260, an example datastore 270, and an example bus 280. The datastore 270 includes and/or stores example sensor data 272, example code(s) 274, and example URI(s) 276. In the illustrated example of FIG. 2, the network interface circuitry 210, the sensor interface circuitry 220, the application interface circuitry 230, the device configuration agent interface circuitry 240, the discover device circuitry 250, the user interface generation circuitry 260, and/or the datastore 270 is/are in communication with one(s) of each other via the bus 280. For example, the bus 280 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 280 can be implemented by any other type of computing or electrical bus.

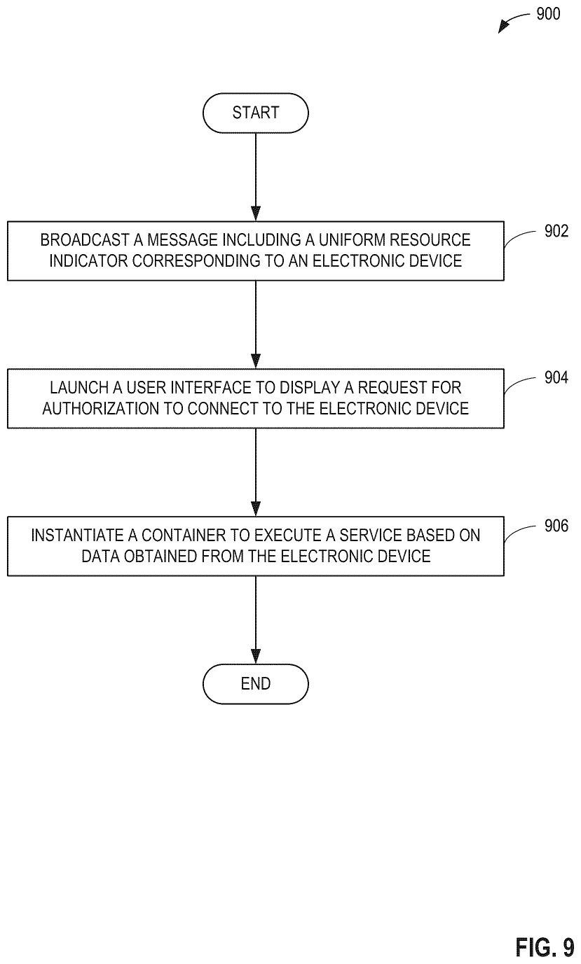

The device configuration agent interface circuitry 200 of FIG. 2 includes the network interface circuitry 210 to obtain and/or transmit data. In some examples, the network interface circuitry 210 is instantiated by processor circuitry executing network interface instructions and/or configured to perform operations such as those represented by one(s) of the flowcharts of FIGS. 9-15.

In some examples, the network interface circuitry 210 can receive and/or cause transmission of data in any form using any type of communication protocol or standard, such as a Bluetooth, BLE, Zigbee, Wi-Fi, Wi-Fi direct, NFC, etc., and/or any combination(s) thereof. In some examples, the network interface circuitry 210 can receive a request for data, such as automation, control, and/or sensor data. In some examples, the network interface circuitry 210 can transmit and/or cause transmission of data, such as a URI, automation data, control data, and/or sensor data.

The device configuration agent interface circuitry 200 of FIG. 2 includes the sensor interface circuitry 220 to capture, measure, and/or obtain data from a sensor, such as an antenna, a camera, a flow rate sensor, a light sensor, a location sensor (e.g., a light detection and ranging (LIDAR) sensor, a radio detection and ranging (RADAR) sensor, etc.), a pressure sensor, a proximity sensor, a temperature sensor, a vibration sensor, etc. For example, the sensor interface circuitry 220 can capture, measure, and/or obtain sensor data, such as the sensor data 272 in the datastore 270. In some examples, the sensor interface circuitry 220 is instantiated by processor circuitry executing sensor interface instructions and/or configured to perform operations such as those represented by one(s) of the flowcharts of FIGS. 9-15.

In some examples, the sensor interface circuitry 220 obtains sensor data from a sensor, such as a camera, to facilitate device connectivity. For example, the sensor interface circuitry 220 can obtain an image of the codes 128A-G from a camera. In some examples, the codes 128A-G of FIG. 1 can be implemented by the code(s) 274 of FIG. 2. In some examples, the sensor interface circuitry 220 can determine that the code(s) 128A-G correspond to a URI of a device. For example, the sensor interface circuitry 220 can store the URI as one of the URI(s) 276 in the datastore 270.

In some examples, the sensor interface circuitry 220 can obtain a temperature measurement from the second electronic device 104 of FIG. 1. In some examples, the sensor interface circuitry 220 can obtain an indication of whether a door or compartment of the first electronic device 102 is open or closed. In some examples, the sensor interface circuitry 220 can obtain a status of whether the seventh electronic device 114 is on or off.

The device configuration agent interface circuitry 200 of FIG. 2 includes the application interface circuitry 230 to obtain data from and/or provide data to an application, such as a software application. In some examples, the application interface circuitry 230 is instantiated by processor circuitry executing application interface instructions and/or configured to perform operations such as those represented by one(s) of the flowcharts of FIGS. 9-15.

In some examples, the application interface circuitry 230 can provide sensor data to an application that is executed and/or instantiated on the same or different device as the application interface circuitry 230. In some examples, the application interface circuitry 230 can trigger an application to discover one(s) of the device configuration agents 140A-D of FIG. 1 to connect to or with.

The device configuration agent interface circuitry 200 of FIG. 2 includes the device configuration agent interface circuitry 240 to obtain data from and/or transmit data to one(s) of the device configuration agents 140A-D of FIG. 1. In some examples, the device configuration agent interface circuitry 240 is instantiated by processor circuitry executing device configuration agent interface instructions and/or configured to perform operations such as those represented by one(s) of the flowcharts of FIGS. 9-15.

The device configuration agent interface circuitry 200 of FIG. 2 includes the discover device circuitry 250 to discover and/or identify a device, such as an electronic and/or endpoint device, to connect to in an effort to obtain and/or provide data. In some examples, the discover device circuitry 250 is instantiated by processor circuitry executing discover device instructions and/or configured to perform operations such as those represented by one(s) of the flowcharts of FIGS. 9-15.

In some examples, the discover device circuitry 250 can discover and/or identify one(s) of the electronic devices 102, 104, 106, 108, 110, 112, 114 and/or one(s) of the endpoint devices 116, 118, 120, 122 using a discovery protocol, such as Simple Service Discovery Protocol (SSDP), Universal Plug and Play (UPnP), Service Location Protocol (SLP), Bluetooth Service Discovery Protocol (SDP), etc. For example, the discover device circuitry 250 can generate a data packet, a message (e.g., a data message), etc., to include a specific service type (e.g., Service:Intel/EvoAgent, Service:Manufacturer/DeviceConfigurationAgent, etc.). In some examples, the discover device circuitry 250 can cause the data packet, the message, etc., to be broadcast (e.g., unicast, multicast, etc.) to listening devices based on the SSDP and/or UPnP protocol(s). For example, the application interface circuitry 230 of the first electronic device 102 can discover the data packet/message from the second electronic device 104 that includes the specific service type. Alternatively, any other discovery protocol or schema may be used such as Web Services Dynamic Discovery (WS-Discovery), Jini (also referred to as Apache River), Bonjour, multicast DNS (mDNS), Named Data Networking (NDN), etc.

The device configuration agent interface circuitry 200 of FIG. 2 includes the user interface generation circuitry 260 to create, generate, display, and/or launch a user interface, such as a GUI. In some examples, the user interface generation circuitry 260 is instantiated by processor circuitry executing user interface generation instructions and/or configured to perform operations such as those represented by one(s) of the flowcharts of FIGS. 9-15.

In some examples, the user interface generation circuitry 260 displays a GUI to request authorization to connect or establish a connection to a device. In some examples, the user interface generation circuitry 260 launches a GUI to present detected one(s) of the device configuration agents 140A-D. For example, the user interface generation circuitry 260 can obtain a selection via the GUI to connect to one(s) of the device configuration agents 140A-D.

The device configuration agent interface circuitry 200 of FIG. 2 includes the datastore 270 to record data, such as the sensor data 272, the code(s) 274, and the URI(s) 276. In some examples, the datastore 270 is instantiated by processor circuitry executing datastore instructions and/or configured to perform operations such as those represented by one(s) of the flowcharts of FIGS. 9-15.

The datastore 270 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 270 may additionally or alternatively be implemented by one or more double data rate (DDR) memories, such as DDR, DDR2, DDR3, DDR4, DDR5, mobile DDR (mDDR), DDR SDRAM, etc. The datastore 270 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 270 is illustrated as a single datastore, the datastore 270 may be implemented by any number and/or type(s) of datastores. Furthermore, the data stored in the datastore 270 may be in any data format such as, for example, binary data, comma delimited data, tab delimited data, structured query language (SQL) structures, etc.

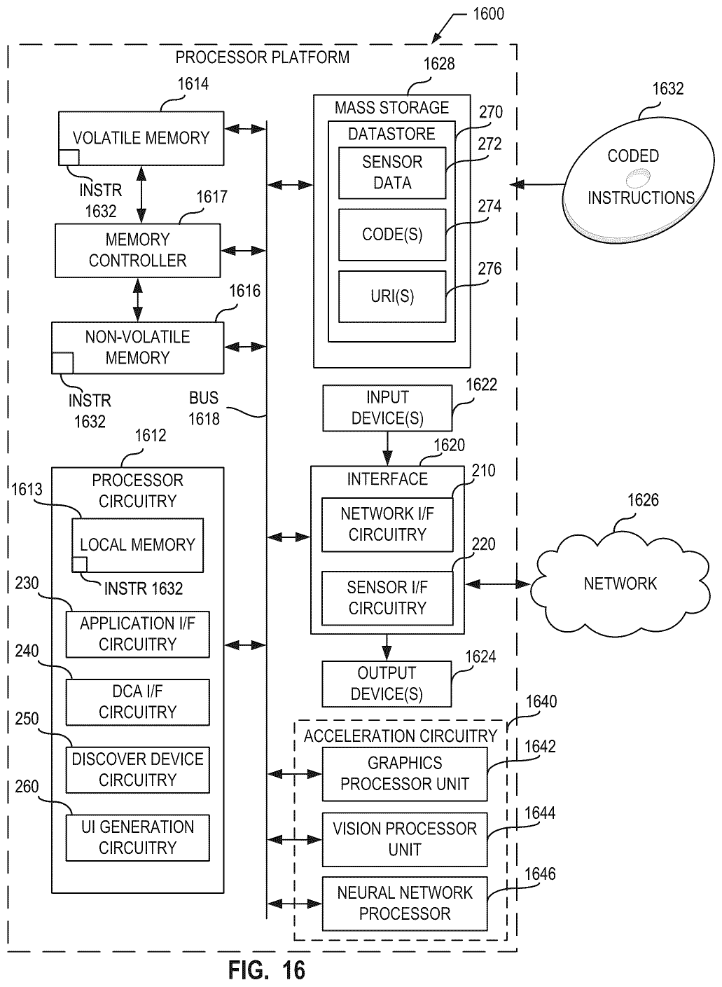

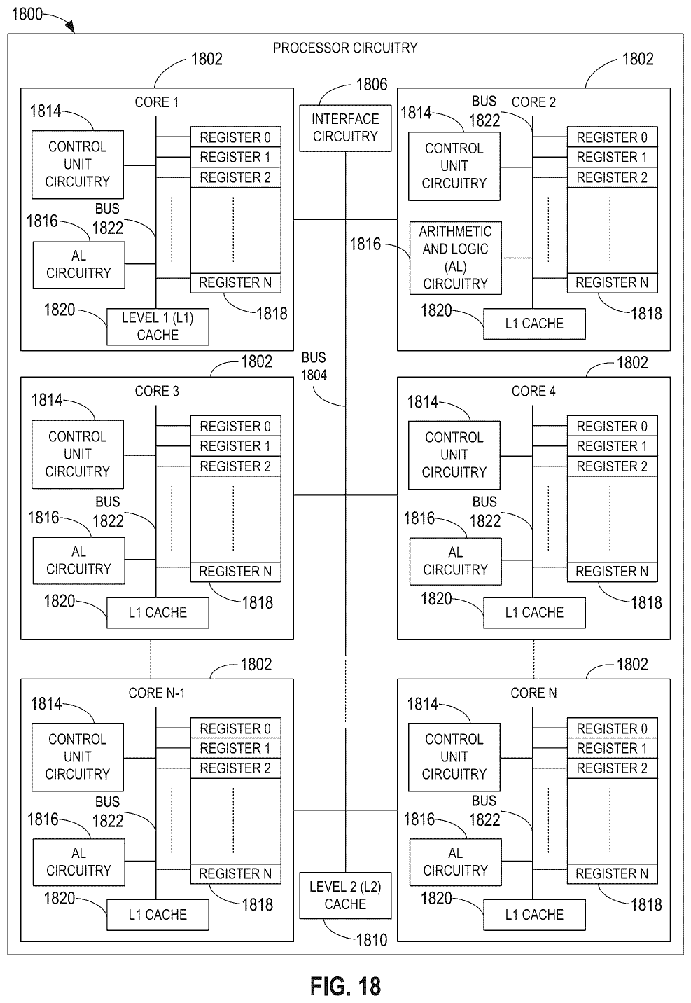

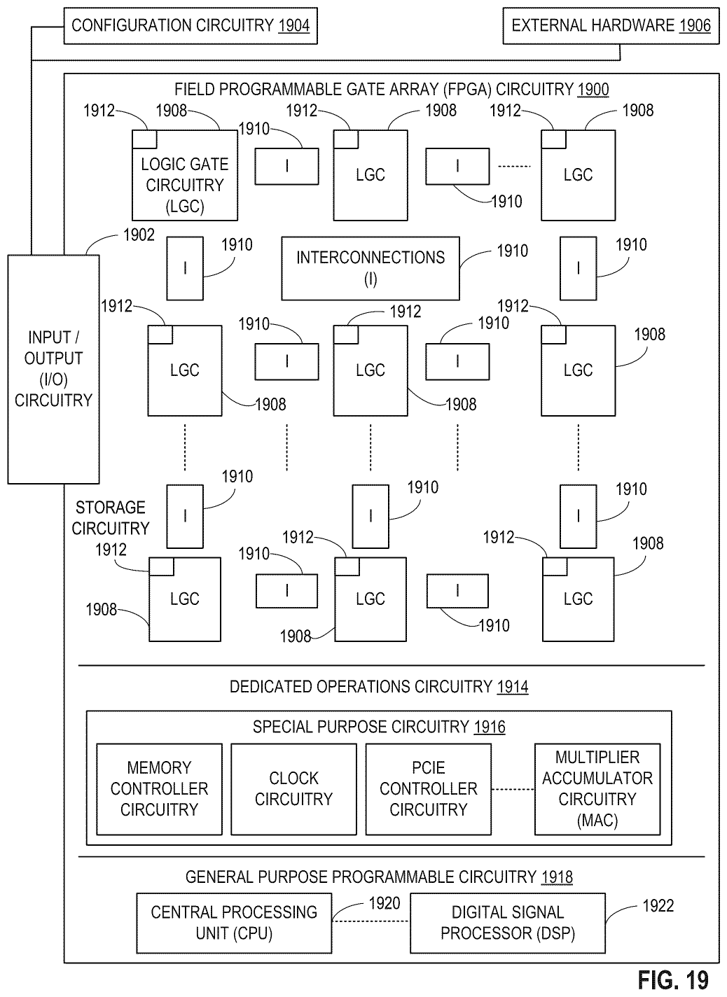

In some examples, the device configuration agent interface circuitry 200 includes means for receiving and/or obtaining and/or transmitting data. For example, the means for obtaining data, the means for receiving data, the means for transmitting data, etc., may be implemented by the network interface circuitry 210. In some examples, the network interface circuitry 210 may be instantiated by processor circuitry such as the example processor circuitry 1612 of FIG. 16. For instance, the network interface circuitry 210 may be instantiated by the example microprocessor 1800 of FIG. 18 executing machine executable instructions such as those implemented by block(s) of one(s) of FIGS. 9-15. In some examples, the network interface circuitry 210 may be instantiated by hardware logic circuitry, which may be implemented by an ASIC, XPU, or the FPGA circuitry 1900 of FIG. 19 structured to perform operations corresponding to the machine readable instructions. Additionally or alternatively, the network interface circuitry 210 may be instantiated by any other combination of hardware, software, and/or firmware. For example, the network interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a transmitter, a receiver, a transceiver, a modem, a residential gateway, a wireless access point, and/or a network interface structured to execute some or all of the machine readable instructions and/or to perform some or all of the operations corresponding to the machine readable instructions without executing software or firmware, but other structures are likewise appropriate.

In some examples, the device configuration agent interface circuitry 200 includes means for capturing and/or measuring and/or obtaining sensor data. For example, the means for capturing sensor data, the means for measuring sensor data, the means for obtaining sensor data, etc., may be implemented by the sensor interface circuitry 220. In some examples, the sensor interface circuitry 220 may be instantiated by processor circuitry such as the example processor circuitry 1612 of FIG. 16. For instance, the sensor interface circuitry 220 may be instantiated by the example microprocessor 1800 of FIG. 18 executing machine executable instructions such as those implemented by block(s) of one(s) of FIGS. 9-15. In some examples, the sensor interface circuitry 220 may be instantiated by hardware logic circuitry, which may be implemented by an ASIC, XPU, or the FPGA circuitry 1900 of FIG. 19 structured to perform operations corresponding to the machine readable instructions. Additionally or alternatively, the sensor interface circuitry 220 may be instantiated by any other combination of hardware, software, and/or firmware. For example, the sensor interface circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent interface circuitry 200 includes means for outputting data to an application. For example, the means for outputting may be implemented by the application interface circuitry 230. In some examples, the application interface circuitry 230 may be instantiated by processor circuitry such as the example processor circuitry 1612 of FIG. 16. For instance, the application interface circuitry 230 may be instantiated by the example microprocessor 1800 of FIG. 18 executing machine executable instructions such as those implemented by block(s) of one(s) of FIGS. 9-15. In some examples, the application interface circuitry 230 may be instantiated by hardware logic circuitry, which may be implemented by an ASIC, XPU, or the FPGA circuitry 1900 of FIG. 19 structured to perform operations corresponding to the machine readable instructions. Additionally or alternatively, the application interface circuitry 230 may be instantiated by any other combination of hardware, software, and/or firmware. For example, the application interface circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent interface circuitry 200 includes means for providing data to a configuration agent interface. For example, the means for providing may be implemented by the device configuration agent interface circuitry 240. In some examples, the device configuration agent interface circuitry 240 may be instantiated by processor circuitry such as the example processor circuitry 1612 of FIG. 16. For instance, the device configuration agent interface circuitry 240 may be instantiated by the example microprocessor 1800 of FIG. 18 executing machine executable instructions such as those implemented by block(s) of one(s) of FIGS. 9-15. In some examples, the device configuration agent interface circuitry 240 may be instantiated by hardware logic circuitry, which may be implemented by an ASIC, XPU, or the FPGA circuitry 1900 of FIG. 19 structured to perform operations corresponding to the machine readable instructions. Additionally or alternatively, the device configuration agent interface circuitry 240 may be instantiated by any other combination of hardware, software, and/or firmware. For example, the device configuration agent interface circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent interface circuitry 200 includes means for discovering a device. For example, the means for discovering may be implemented by the discover device circuitry 250. In some examples, the discover device circuitry 250 may be instantiated by processor circuitry such as the example processor circuitry 1612 of FIG. 16. For instance, the discover device circuitry 250 may be instantiated by the example microprocessor 1800 of FIG. 18 executing machine executable instructions such as those implemented by block(s) of one(s) of FIGS. 9-15. In some examples, the discover device circuitry 250 may be instantiated by hardware logic circuitry, which may be implemented by an ASIC, XPU, or the FPGA circuitry 1900 of FIG. 19 structured to perform operations corresponding to the machine readable instructions. Additionally or alternatively, the discover device circuitry 250 may be instantiated by any other combination of hardware, software, and/or firmware. For example, the discover device circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent interface circuitry 200 includes means for generating, launching, and/or presenting a user interface. For example, the means for generating, the means for launching, the means for presenting, etc., may be implemented by the user interface generation circuitry 260. In some examples, the user interface generation circuitry 260 may be instantiated by processor circuitry such as the example processor circuitry 1612 of FIG. 16. For instance, the user interface generation circuitry 260 may be instantiated by the example microprocessor 1800 of FIG. 18 executing machine executable instructions such as those implemented by block(s) of one(s) of FIGS. 9-15. In some examples, the user interface generation circuitry 260 may be instantiated by hardware logic circuitry, which may be implemented by an ASIC, XPU, or the FPGA circuitry 1900 of FIG. 19 structured to perform operations corresponding to the machine readable instructions. Additionally or alternatively, the user interface generation circuitry 260 may be instantiated by any other combination of hardware, software, and/or firmware. For example, the user interface generation circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent interface circuitry 200 includes means for storing data. For example, the means for storing may be implemented by the datastore 270. In some examples, the datastore 270 may be instantiated by processor circuitry such as the example processor circuitry 1612 of FIG. 16. For instance, the datastore 270 may be instantiated by the example microprocessor 1800 of FIG. 18 executing machine executable instructions such as those implemented by block(s) of one(s) of FIGS. 9-15. In some examples, the datastore 270 may be instantiated by hardware logic circuitry, which may be implemented by an ASIC, XPU, or the FPGA circuitry 1900 of FIG. 19 structured to perform operations corresponding to the machine readable instructions. Additionally or alternatively, the datastore 270 may be instantiated by any other combination of hardware, software, and/or firmware. For example, the datastore 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the device configuration agent interfaces 130A-G of FIG. 1 is illustrated in FIG. 2, one or more of the elements, processes, and/or devices illustrated in FIG. 2 may be combined, divided, re-arranged, omitted, eliminated, and/or implemented in any other way. Further, the network interface circuitry 210, the sensor interface circuitry 220, the application interface circuitry 230, the device configuration agent interface circuitry 240, the discover device circuitry 250, the user interface generation circuitry 260, and/or the datastore 270, and/or, more generally, the example device configuration agent interfaces 130A-G of FIG. 1, may be implemented by hardware alone or by hardware in combination with software and/or firmware. Thus, for example, any of the network interface circuitry 210, the sensor interface circuitry 220, the application interface circuitry 230, the device configuration agent interface circuitry 240, the discover device circuitry 250, the user interface generation circuitry 260, and/or the datastore 270, and/or, more generally, the example device configuration agent interfaces 130A-G of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example device configuration agent interfaces 130A-G of FIG. 1 may include one or more elements, processes, and/or devices in addition to, or instead of, those illustrated in FIG. 2, and/or may include more than one of any or all of the illustrated elements, processes and devices.

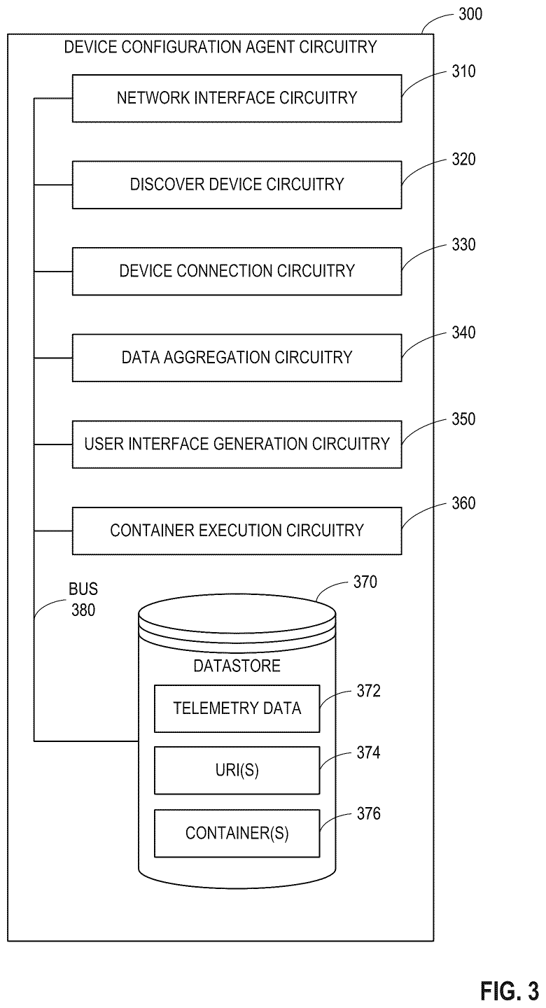

FIG. 3 is a block diagram of an implementation of example device configuration agent circuitry 300 to establish connection(s) between device(s). In some examples, respective ones of the device configuration agents 140A-D of FIG. 1 can be implemented by the device configuration agent circuitry 300 of FIG. 3. The device configuration agent circuitry 300 of FIG. 3 of FIG. 3 may be instantiated (e.g., creating an instance of, bring into being for any length of time, materialize, implement, etc.) by processor circuitry such as a central processing unit executing instructions. Additionally or alternatively, the device configuration agent circuitry 300 of FIG. 3 may be instantiated (e.g., creating an instance of, bring into being for any length of time, materialize, implement, etc.) by an ASIC or an FPGA structured to perform operations corresponding to the instructions. It should be understood that some or all of the device configuration agent circuitry 300 of FIG. 3 may, thus, be instantiated at the same or different times. Some or all of the device configuration agent circuitry 300 of FIG. 3 may be instantiated, for example, in one or more threads executing concurrently on hardware and/or in series on hardware. Moreover, in some examples, some or all of the device configuration agent circuitry 300 of FIG. 3 may be implemented by microprocessor circuitry executing instructions to implement one or more virtual machines and/or containers.

The device configuration agent circuitry 300 of FIG. 3 includes example network interface circuitry 310, example discover device circuitry 320, example device connection circuitry 330, example data aggregation circuitry 340, example user interface generation circuitry 350, example container execution circuitry 360, an example datastore 370, and an example bus 380. The datastore 370 includes and/or stores example telemetry data 372, example URI(s) 374, and example container(s) 376. In the illustrated example of FIG. 3, the network interface circuitry 310, the discover device circuitry 320, the device connection circuitry 330, the data aggregation circuitry 340, the user interface generation circuitry 350, the container execution circuitry 360, and/or the datastore 370 is/are in communication with one(s) of each other via the bus 380. For example, the bus 380 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 380 can be implemented by any other type of computing or electrical bus.

The device configuration agent circuitry 300 of the illustrated example of FIG. 3 includes the network interface circuitry 310 to obtain and/or transmit data, such as the telemetry data 372. In some examples, the network interface circuitry 310 is instantiated by processor circuitry executing network interface instructions and/or configured to perform operations such as those represented by one(s) of the flowcharts of FIGS. 9-15.

In some examples, the network interface circuitry 310 can receive and/or cause transmission of data in any form using any type of communication protocol or standard, such as a Bluetooth, BLE, Zigbee, Wi-Fi, Wi-Fi direct, NFC, etc., and/or any combination(s) thereof. For example, the network interface circuitry 310 can receive and/or obtain data from one(s) of the electronic devices 102, 104, 106, 108, 110, 112, 114 using Bluetooth, BLE, Zigbee, Wi-Fi, Wi-Fi direct, NFC, etc., and/or any combination(s) thereof. In some examples, the network interface circuitry 310 can receive a request for data, such as automation, control, and/or sensor data from a server, such as the cloud server 126 of FIG. 1, and/or from an endpoint device, such as one(s) of the endpoint devices 116, 118, 120, 122 of FIG. 1. In some examples, the network interface circuitry 310 can transmit and/or cause transmission of data, such as a URI, automation data, control data, and/or sensor data to a server, such as the cloud server 126 of FIG. 1. The network interface circuitry 310 can store transmitted data and/or received data as the telemetry data 372 in the datastore 370. For example, the telemetry data 372 can include sensor data from an electronic device, device connection data (e.g., an identification of hardware, software, and/or firmware needed to connect to a device), etc.

In some examples, the network interface circuitry 310 can implement a mesh network between devices, such as between one(s) of the electronic devices 102, 104, 106, 108, 110, 112, 114, between one(s) of the endpoint devices 116, 118, 120, 122, etc., and/or any combination(s) thereof. For example, a user can interact with the first endpoint device 116, which can be paired with the first electronic device 102, to add another endpoint device, such as the second endpoint device 118, to the configuration with the first electronic device 102. In some examples, the network interface circuitry 310 can establish a mesh network between the first device configuration agent 140A and the second device configuration agent 140B. In some examples, the first electronic device 102 can transmit data to any one(s) of the first device configuration agent 140A and/or the second device configuration agent 140B, such as whichever one(s) is/are nearby and/or readily reachable through the supported communication techniques or protocols. In some examples, the first device configuration agent 140A and/or the second device configuration agent 140B can share and/or propagate data from the first electronic device 102 to other one(s) of the device configuration agents 140A-D.

The device configuration agent circuitry 300 of the illustrated example of FIG. 3 includes the discover device circuitry 320 to discover and/or identify a device, such as an electronic and/or endpoint device, to connect to in an effort to obtain and/or provide data. In some examples, the discover device circuitry 320 is instantiated by processor circuitry executing discover device instructions and/or configured to perform operations such as those represented by one(s) of the flowcharts of FIGS. 9-15.

In some examples, the discover device circuitry 320 can discover a device by capturing, detecting, processing, and/or identifying data to facilitate device connectivity. For example, the discover device circuitry 320 can obtain an image of the codes 128A-G from a sensor, such as a camera. In some examples, the discover device circuitry 320 can determine that the code(s) 128A-G correspond to a URI of a device. In some examples, the discover device circuitry 320 can detect data using an RFID sensor, controller, terminal, etc., that is representative of a URI of a nearby or geographically proximate electronic device. In some examples, the discover device circuitry 320 can detect data using an NFC sensor, controller, terminal, etc., that is representative of a URI of a nearby or geographically proximate electronic device. In some examples, the discover device circuitry 320 can store the URI as one of the URI(s) 374 in the datastore 370.

In some examples, the discover device circuitry 320 can discover and/or identify one(s) of the electronic devices 102, 104, 106, 108, 110, 112, 114 and/or one(s) of the endpoint devices 116, 118, 120, 122 using a discovery protocol, such as SSDP, UPnP, etc. For example, the discover device circuitry 320 can generate a data packet, a message (e.g., a data message), etc., to include a specific service type (e.g., Service:Intel/EvoAgent, Service:Manufacturer/DeviceConfigurationAgent, etc.). In some examples, the discover device circuitry 320 can cause the data packet, the message, etc., to be broadcast (e.g., unicast, multicast, etc.) to listening devices based on the SSDP and/or UPnP protocol(s). For example, the application interface circuitry 230 of the first electronic device 102 can discover the data packet/message from the second electronic device 104 that includes the specific service type. In some examples, the discover device circuitry 320 can obtain a data packet, a message, etc., that includes a specific service type and identify a device based on the specific service type.

The device configuration agent circuitry 300 of the illustrated example of FIG. 3 includes the device connection circuitry 330 to establish a connection to one or more devices. In some examples, the device connection circuitry 330 is instantiated by processor circuitry executing device connection instructions and/or configured to perform operations such as those represented by one(s) of flowcharts of FIGS. 9-15.

In some examples, the device connection circuitry 330 establishes a connection to the electronic devices 102, 104, 106, 108, 110, 112, 114 by generating and/or transmitting packets, messages, etc., with an additional transport stack or layer on top of a conventional communication protocol, such as Bluetooth, BLE, Wi-Fi, Thread, Zigbee, etc. In some examples, the device connection circuitry 330 can establish a connection to the electronic devices 102, 104, 106, 108, 110, 112, 114 by identifying a received packet, message, etc., as having an additional transport stack or layer on top of a conventional communication protocol and determining that the sending device is associated with examples disclosed herein.

The device configuration agent circuitry 300 of the illustrated example of FIG. 3 includes the data aggregation circuitry 340 to obtain and/or aggregate data from one or more data sources, such as one(s) of the electronic devices 102, 104, 106, 108, 110, 112, 114, one(s) of the endpoint devices 116, 118, 120, 122, the cloud server 126, etc., and/or any combination(s) thereof. In some examples, the data aggregation circuitry 340 is instantiated by processor circuitry executing data aggregation instructions and/or configured to perform operations such as those represented by one(s) of flowcharts of FIGS. 9-15.

The device configuration agent circuitry 300 of the illustrated example of FIG. 3 includes the user interface generation circuitry 350 to create, generate, display, and/or launch a user interface, such as a GUI. In some examples, the user interface generation circuitry 350 is instantiated by processor circuitry executing user interface generation instructions and/or configured to perform operations such as those represented by one(s) of the flowcharts of FIGS. 9-15.

In some examples, the user interface generation circuitry 350 displays a GUI to request authorization to connect or establish a connection to a device, such as an electronic device. For example, the user interface generation circuitry 350 can display a GUI to present detected one(s) of the electronic devices 102, 104, 106, 108, 110, 112, 114. The user interface generation circuitry 350 can obtain a selection via the GUI to connect to one(s) of the electronic devices 102, 104, 106, 108, 110, 112, 114.

In some examples, the user interface generation circuitry 350 launches a GUI to present detected one(s) of the device configuration agents 140A-D. For example, the user interface generation circuitry 350 can obtain a selection via the GUI to connect to one(s) of the device configuration agents 140A-D.

The device configuration agent circuitry 300 of the illustrated example of FIG. 3 includes the container execution circuitry 360 to execute and/or instantiate a container, a service, etc., in an execution environment (e.g., a container execution environment). In some examples, the container execution circuitry 360 is instantiated by processor circuitry executing container execution instructions and/or configured to perform operations such as those represented by one(s) of flowcharts of FIGS. 9-15. In some examples, the container execution circuitry 360 executes and/or instantiates a container, such as one of the container(s) 376, to carry out, perform, and/or otherwise execute a workload (e.g., a computing and/or electronic workload). In some examples, the workloads can be artificial intelligence and/or machine-learning workloads.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the container execution circuitry 360 can execute the container(s) 376 to implement an AI/ML model, which may be trained with data to recognize patterns and/or associations and follow such patterns and/or associations when processing input data such that other input(s) result in output(s) (e.g., machine-learning output(s)) consistent with the recognized patterns and/or associations.

Many different types of machine-learning models and/or machine-learning architectures exist. In some examples, the container(s) 376 is/are neural network model(s). Using a neural network model enables the container execution circuitry 360 to execute an AI/ML workload. In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the container(s) 376 may be compiled and/or otherwise generated as lightweight machine-learning models.

In general, implementing an ML/AI system involves two phases, a learning/training phase and an inference phase. In the learning/training phase, a training algorithm is used to train the machine-learning model(s) to operate in accordance with patterns and/or associations based on, for example, training data. In general, the machine-learning model(s) include(s) internal parameters that guide how input data is transformed into output data, such as through a series of nodes and connections within the machine-learning model(s) to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the machine-learning model(s) may be trained using supervised training by using inputs and corresponding expected (e.g., labeled) outputs to select parameters (e.g., by iterating over combinations of select parameters) for the machine-learning model(s) that reduce model error. As used herein, “labeling” refers to an expected output of the machine learning model (e.g., a classification, an expected output value, etc.). Alternatively, the machine-learning model(s) may be trained using unsupervised training (e.g., used in deep learning, a subset of machine learning, etc.) that involves inferring patterns from inputs to select parameters for the machine-learning model(s) (e.g., without the benefit of expected (e.g., labeled) outputs).

In some examples, the machine-learning model(s) can be trained using unsupervised clustering of operating observables. For example, the operating observables may include the telemetry data 372, the URI(s) 374, etc. However, the machine-learning model(s) may additionally or alternatively be trained using any other training algorithm such as stochastic gradient descent, Simulated Annealing, Particle Swarm Optimization, Evolution Algorithms, Genetic Algorithms, Nonlinear Conjugate Gradient, etc.

In some examples, the machine-learning model(s) may be trained until the level of error is no longer reducing. In some examples, the machine-learning model(s) may be trained locally on the endpoint devices 116, 118, 120, 122 and/or remotely at an external computing system (e.g., the cloud server 126) communicatively coupled to the endpoint devices 116, 118, 120, 122. In some examples, the machine-learning model(s) is/are trained using hyperparameters that control how the learning is performed (e.g., a learning rate, a number of layers to be used in the machine learning model, etc.). In some examples, hyperparameters such as those that control model performance and training speed such as the learning rate and regularization parameter(s). The hyperparameters may be selected by, for example, trial and error to reach an optimal model performance. In some examples, the Bayesian hyperparameter optimization may be utilized to determine an optimal and/or otherwise improved or more efficient network architecture to avoid model overfitting and improve the overall applicability of the machine-learning model(s). Alternatively, any other type of optimization may be used. In some examples, the machine-learning model(s) may be retrained, such as in response to override(s) by a user of the endpoint devices 116, 118, 120, 122, a receipt of new training data, etc.

In some examples, the training of the machine-learning model(s) is based on using training data. In some examples, the training data originates from locally generated data, such as the telemetry data 372, the URI(s) 374, etc. In some examples, the machine-learning model(s) are trained using training data that originates from externally generated data, such as telemetry data at a different endpoint device.

Once training is complete, the machine-learning model(s) may be deployed for use as an executable construct that processes an input and provides an output based on the network of nodes and connections defined in the machine-learning model(s). For example, the executable construct(s) can be stored in a repository or database accessible and/or maintained by the cloud server 126. In some examples, the network interface circuitry 310 may request the cloud server 126 to transmit the machine-learning model(s) to the device configuration agent circuitry 300 to store as the container(s). The container execution circuitry 360 can execute the container(s) 376 to implement machine-learning model(s) to execute AI/ML workloads with at least one of improved efficiency or performance.

Once trained, the deployed one(s) of the machine-learning model(s) may be operated in an inference phase to process data. In the inference phase, data to be analyzed (e.g., live data) is input to the machine-learning model(s), and the machine-learning model(s) execute(s) to create an output. This inference phase can be thought of as the AI “thinking” to generate the output based on what it learned from the training (e.g., by executing the machine-learning model(s) to apply the learned patterns and/or associations to the live data). In some examples, input data undergoes pre-processing before being used as an input to the machine-learning model(s). Moreover, in some examples, the output data may undergo post-processing after it is generated by the machine-learning model(s) to transform the output into a useful result (e.g., a display of data such as a GUI or dashboard, a detection and/or identification of an object, an instruction to be executed by a machine, an automation and/or control command or action, etc.).

In some examples, output of the deployed one(s) of the machine-learning model(s) may be captured and provided as feedback. By analyzing the feedback, an accuracy of the deployed one(s) of the machine-learning model(s) can be determined. If the feedback indicates that the accuracy of the deployed model is less than a threshold or other criterion, training of an updated model can be triggered using the feedback and an updated training data set, hyperparameters, etc., to generate an updated, deployed model.

Turning back to the illustrated example of FIG. 3, the device configuration agent circuitry 300 includes the datastore 370 to record data, such as the telemetry data 372, the URI(s) 374, and the container(s) 376. In some examples, the datastore 370 is instantiated by processor circuitry executing datastore instructions and/or configured to perform operations such as those represented by one(s) of the flowcharts of FIGS. 9-15.

The datastore 370 may be implemented by a volatile memory (e.g., a SDRAM, DRAM, RDRAM, etc.) and/or a non-volatile memory (e.g., flash memory). The datastore 370 may additionally or alternatively be implemented by one or more DDR memories, such as DDR, DDR2, DDR3, DDR4, DDR5, mDDR, DDR SDRAM, etc. The datastore 370 may additionally or alternatively be implemented by one or more mass storage devices such as HDD(s), CD drive(s), DVD drive(s), SSD drive(s), SD card(s), CF card(s), etc. While in the illustrated example the datastore 370 is illustrated as a single datastore, the datastore 370 may be implemented by any number and/or type(s) of datastores. Furthermore, the data stored in the datastore 370 may be in any data format such as, for example, binary data, comma delimited data, tab delimited data, SQL structures, etc.

In some examples, the device configuration agent circuitry 300 includes means for receiving and/or obtaining and/or transmitting data. For example, the means for receiving, the means for obtaining, and/or the means for transmitting may be implemented by the network interface circuitry 310. In some examples, the network interface circuitry 310 may be instantiated by processor circuitry such as the example processor circuitry 1612 of FIG. 16. For instance, the network interface circuitry 310 may be instantiated by the example microprocessor 1800 of FIG. 18 executing machine executable instructions such as those implemented by at least block(s) of one(s) of FIGS. 9-15. In some examples, the network interface circuitry 310 may be instantiated by hardware logic circuitry, which may be implemented by an ASIC, XPU, or the FPGA circuitry 1900 of FIG. 19 structured to perform operations corresponding to the machine readable instructions. Additionally or alternatively, the network interface circuitry 310 may be instantiated by any other combination of hardware, software, and/or firmware. For example, the network interface circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a transmitter, a receiver, a transceiver, a modem, a residential gateway, a wireless access point, and/or a network interface structured to execute some or all of the machine readable instructions and/or to perform some or all of the operations corresponding to the machine readable instructions without executing software or firmware, but other structures are likewise appropriate.

In some examples, the device configuration agent circuitry 300 includes means for discovering, detecting, and/or identifying a device. For example, the means for discovering, the means for detecting, the means for identifying, etc., may be implemented by the discover device circuitry 320. In some examples, the discover device circuitry 320 may be instantiated by processor circuitry such as the example processor circuitry 1612 of FIG. 16. For instance, the discover device circuitry 320 may be instantiated by the example microprocessor 1800 of FIG. 18 executing machine executable instructions such as those implemented by at least block(s) of one(s) of FIGS. 9-15. In some examples, the discover device circuitry 320 may be instantiated by hardware logic circuitry, which may be implemented by an ASIC, XPU, or the FPGA circuitry 1900 of FIG. 19 structured to perform operations corresponding to the machine readable instructions. Additionally or alternatively, the discover device circuitry 320 may be instantiated by any other combination of hardware, software, and/or firmware. For example, the discover device circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent circuitry 300 includes means for establishing a connection to a device and/or connecting to a device. For example, the means for establishing, the means for connecting, etc., may be implemented by the device connection circuitry 330. In some examples, the device connection circuitry 330 may be instantiated by processor circuitry such as the example processor circuitry 1612 of FIG. 16. For instance, the device connection circuitry 330 may be instantiated by the example microprocessor 1800 of FIG. 18 executing machine executable instructions such as those implemented by at least block(s) of one(s) of FIGS. 9-15. In some examples, the device connection circuitry 330 may be instantiated by hardware logic circuitry, which may be implemented by an ASIC, XPU, or the FPGA circuitry 1900 of FIG. 19 structured to perform operations corresponding to the machine readable instructions. Additionally or alternatively, the device connection circuitry 330 may be instantiated by any other combination of hardware, software, and/or firmware. For example, the device connection circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent circuitry 300 includes means for aggregating data. For example, the means for aggregating may be implemented by the data aggregation circuitry 340. In some examples, the data aggregation circuitry 340 may be instantiated by processor circuitry such as the example processor circuitry 1612 of FIG. 16. For instance, the data aggregation circuitry 340 may be instantiated by the example microprocessor 1800 of FIG. 18 executing machine executable instructions such as those implemented by at least block(s) of one(s) of FIGS. 9-15. In some examples, the data aggregation circuitry 340 may be instantiated by hardware logic circuitry, which may be implemented by an ASIC, XPU, or the FPGA circuitry 1900 of FIG. 19 structured to perform operations corresponding to the machine readable instructions. Additionally or alternatively, the data aggregation circuitry 340 may be instantiated by any other combination of hardware, software, and/or firmware. For example, the data aggregation circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent circuitry 300 includes means for generating, launching, and/or presenting a user interface. For example, the means for generating, the means for launching, the means for presenting, etc., may be implemented by the user interface generation circuitry 350. In some examples, the user interface generation circuitry 350 may be instantiated by processor circuitry such as the example processor circuitry 1612 of FIG. 16. For instance, the user interface generation circuitry 350 may be instantiated by the example microprocessor 1800 of FIG. 18 executing machine executable instructions such as those implemented by at least block(s) of one(s) of FIGS. 9-15. In some examples, the user interface generation circuitry 350 may be instantiated by hardware logic circuitry, which may be implemented by an ASIC, XPU, or the FPGA circuitry 1900 of FIG. 19 structured to perform operations corresponding to the machine readable instructions. Additionally or alternatively, the user interface generation circuitry 350 may be instantiated by any other combination of hardware, software, and/or firmware. For example, the user interface generation circuitry 350 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent circuitry 300 includes means for executing a container. For example, the means for executing may be implemented by the container execution circuitry 360. In some examples, the container execution circuitry 360 may be instantiated by processor circuitry such as the example processor circuitry 1612 of FIG. 16. For instance, the container execution circuitry 360 may be instantiated by the example microprocessor 1800 of FIG. 18 executing machine executable instructions such as those implemented by at least block(s) of one(s) of FIGS. 9-15. In some examples, the container execution circuitry 360 may be instantiated by hardware logic circuitry, which may be implemented by an ASIC, XPU, or the FPGA circuitry 1900 of FIG. 19 structured to perform operations corresponding to the machine readable instructions. Additionally or alternatively, the container execution circuitry 360 may be instantiated by any other combination of hardware, software, and/or firmware. For example, the container execution circuitry 360 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device configuration agent circuitry 300 includes means for storing data. For example, the means for storing may be implemented by the datastore 370. In some examples, the datastore 370 may be instantiated by processor circuitry such as the example processor circuitry 1612 of FIG. 16. For instance, the datastore 370 may be instantiated by the example microprocessor 1800 of FIG. 18 executing machine executable instructions such as those implemented by at least block(s) of one(s) of FIGS. 9-15. In some examples, the datastore 370 may be instantiated by hardware logic circuitry, which may be implemented by an ASIC, XPU, or the FPGA circuitry 1900 of FIG. 19 structured to perform operations corresponding to the machine readable instructions. Additionally or alternatively, the datastore 370 may be instantiated by any other combination of hardware, software, and/or firmware. For example, the datastore 370 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the device configuration agents 140A-D of FIG. 1 is illustrated in FIG. 3, one or more of the elements, processes, and/or devices illustrated in FIG. 3 may be combined, divided, re-arranged, omitted, eliminated, and/or implemented in any other way. Further, the network interface circuitry 310, the discover device circuitry 320, the device connection circuitry 330, the data aggregation circuitry 340, the user interface generation circuitry 350, the container execution circuitry 360, and/or the datastore 370, and/or, more generally, the example device configuration agents 140A-D of FIG. 1, may be implemented by hardware alone or by hardware in combination with software and/or firmware. Thus, for example, any of the network interface circuitry 310, the discover device circuitry 320, the device connection circuitry 330, the data aggregation circuitry 340, the user interface generation circuitry 350, the container execution circuitry 360, and/or the datastore 370, and/or, more generally, the example device configuration agents 140A-D, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example device configuration agents 140A-D of FIG. 1 may include one or more elements, processes, and/or devices in addition to, or instead of, those illustrated in FIG. 3, and/or may include more than one of any or all of the illustrated elements, processes and devices.

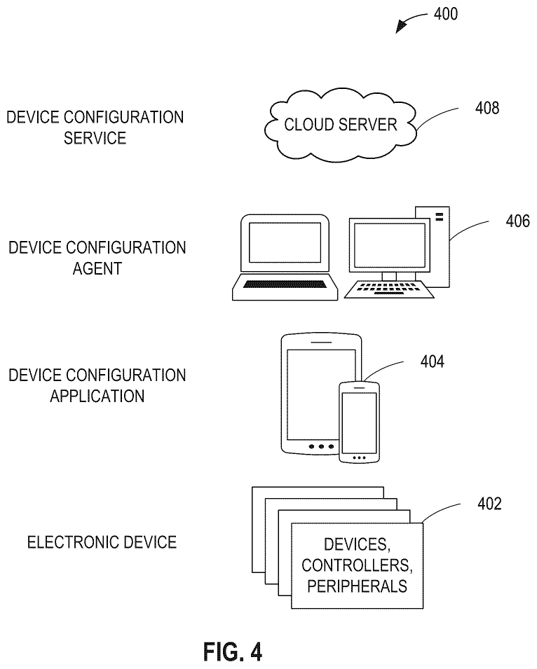

FIG. 4 is an example device connectivity system architecture 400 to implement examples disclosed herein. The device connectivity system architecture 400 includes example electronic devices 402, example device configuration applications 404, example device configuration agents 406, and an example device configuration service 408. In some examples, one(s) of the electronic devices 102, 104, 106, 108, 110, 112, 114 of FIG. 1 can be implemented by and/or correspond to the electronic devices 402 of FIG. 4. In some examples, one(s) of the device configuration agent interfaces 130A-130G can be implemented by and/or correspond to the device configuration applications 404 of FIG. 4. In some examples, one(s) of the device configuration agents 140A-D of FIG. 1 can be implemented by and/or correspond to the device configuration agents 406 of FIG. 4. In some examples, the cloud server 126 of FIG. 1 can be implemented by and/or correspond to the device configuration service 408 of FIG. 4.

In the illustrated example of FIG. 4, the electronic devices 402 include devices, controllers, and/or peripherals. For example, the electronic devices 402 can vary on the sophistication and intelligence available on the devices. For example, the electronic devices 402 can include pointing devices (e.g., laser pointers), cameras (e.g., security cameras, surveillance cameras, etc.), microphones, headphones, headsets, controllers (e.g., home automation controllers), smart home devices (e.g., Amazon® Echo®, Google Home Hub™ smart home controller, a controller that controls a lawn sprinkler system, a smart thermostat, a lighting controller, a kitchen weighing machine or scale, etc.), a wearable device (e.g., a blood pressure monitor, a blood sugar smart patch, etc.), etc. In some examples, the electronic devices 402 may not utilize any necessary agents other than one of the transport stacks that allow them to communicate with the device configuration applications 404 and/or the device configuration agents 406 over an IP-based protocol (or any other type of communication protocol). In some examples, the device configuration agents 406, or portion(s) thereof, can be included in and/or installed on the electronic devices 402 for enhanced capability.

The device configuration applications 404 of the illustrated example can be executed and/or instantiated by electronic devices and/or endpoint devices such as a tablet computer, a smartphone, etc. The device configuration agents 406 of the illustrated example can be executed and/or instantiated by endpoint devices such as a laptop computer, a desktop computer, or any other type of electronic and/or computing device. The device configuration service 408 of the illustrated example can be executed and/or instantiated by a cloud server, such as the cloud server 126 of FIG. 1.

In some examples, the device configuration service 408 is a cloud-based or hosted service that provides a portal, a registry, a database, a repository, etc. In some examples, the portal, the registry, etc., can be for device hardware vendors or integrators that ship and/or provide electronic devices to consumers to register their electronic devices and obtain a URI, such as a vendor-device-model uniform resource indicator (VDM-URI) or vendor-device-model specific URI, for their specific electronic device and model. In some examples, the URI structure (e.g., the VDM-URI structure) or format enables the vendor/integrator to obtain a single URI. In some examples, the URI structure/format allows the vendor/integrator to obtain or one or more URIs and extend the one or more URIs to themselves to generate multiple URIs in a structured format. In some examples, the device configuration service 408 can generate a code such as a QR code based on a URI and/or data representative of the URI that can be associated with an RFID tag, NFC device, etc. In some examples, the device configuration service 408 can include and/or implement a container repository, database, etc., that hosts containers, such as the container(s) 376 of FIG. 3.

In some examples, the device configuration agents 406 can be implemented by a collection of components (e.g., software components, firmware components, etc.) that reside and/or are included on an endpoint device. In some examples, the endpoint device can be an edge device, such as a gateway (e.g., an edge gateway), a router (e.g., an edge router), etc.

In some examples, the device configuration agents 406 include, execute, and/or instantiate a transport stack for Internet Protocol (IP) level communications over any contemplated transport channel or medium, such as Bluetooth, BLE, Wi-Fi, LAN, Thread, Zigbee, etc. In some examples, the transport stack can be optimized and/or otherwise improved versions of standards-based drivers and components for low-power and/or low-latency performance. In some examples, the device configuration agents 406 can execute and/or instantiate the transport stack to implement a mesh network with one or more other device configuration agents 406.

In some examples, the device configuration agents 406 include, execute, and/or instantiate a discovery stack on top of a discovery protocol, such as UPnP, mDNS, etc., to identify broadcasted specific service categories that effectuate device connectivity as disclosed herein. For example, the device configuration agents 406 can execute and/or instantiate the discovery stack to discover other ones of the device configuration agents 406 on a network and/or in proximity to the discovering device configuration agent. In some examples, the execution and/or instantiation of the discovery stack can enable the device configuration applications 404 to discover the device configuration agents 406. In some examples, the execution and/or instantiation of the discovery stack can enable the electronic devices 402 to discover the device configuration agents 406.

In some examples, the discovery stack can include and/or be implemented by BLE received signal strength indicator (RSSI) signals and/or data to achieve location determination accuracy within approximately 3 meters. In some examples, the discovery stack can include and/or be implemented by BLE high accuracy distance measurement (HADM) or sounding signals and/or data to achieve location determination accuracy within approximately 1 meter. In some examples, the discovery stack can include and/or be implemented by Wi-Fi time-of-flight (ToF) and/or fine timing measurement (FTM) within approximately 1-2 meters. In some examples, the discovery stack can include and/or be implemented by ultra-wideband (UWB) high rate pulse (HRP) signals and/or data to achieve location determination accuracy within approximately 10 centimeters. In some examples, the discovery stack can include and/or be implemented by frequency division multiple access (FDMA) signals and/or data to achieve location determination accuracy within approximately a few millimeters (e.g., 1 millimeter, 5 millimeters, 10 millimeters, etc.).

In some examples, the device configuration agents 406 include, execute, and/or instantiate containers (e.g., software containers) in a container execution environment. For example, the device configuration agents 406 can execute and/or instantiate a container to generate an output (e.g., a data output, a control and/or automation output, a machine-learning output, etc.) based on data from the electronic devices 402, which can include sensor data, telemetry data, control and/or automation data, etc.

In some examples, the device configuration agents 406 execute and/or instantiate containers to implement functions (e.g., delta functions) that, once executed and/or instantiated, can connect (e.g., directly connect) to the software running on the electronic devices 402. For example, the functions can be a set or collection of functions that are packaged, compiled, and/or otherwise assembled into one or more containers to achieve portability across different execution environments, operating systems, and/or the like. In some examples, the functions can be generated and/or provided by vendors/manufacturers of the electronic devices 402. The vendors/manufacturers can generate the functions in any format or based on any communication protocol to achieve improved flexibility for types of the electronic devices 402 not yet known.

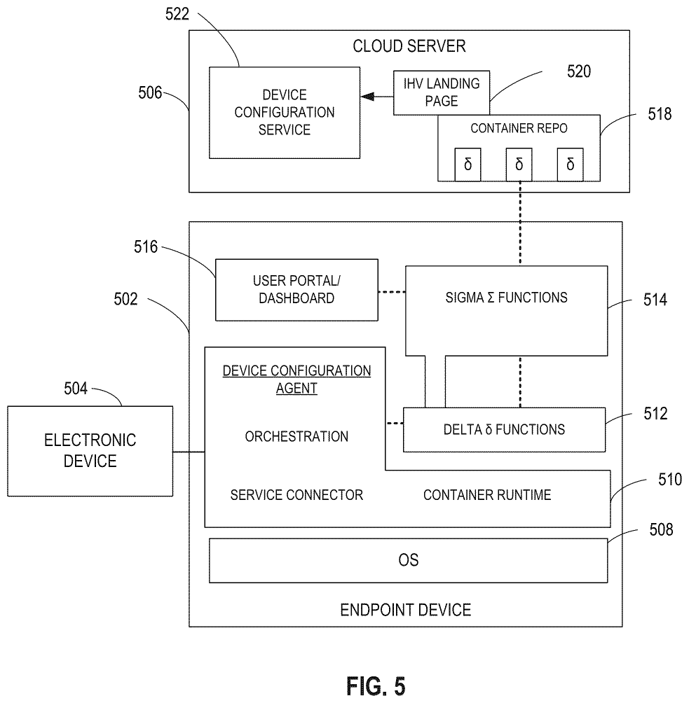

FIG. 5 is an implementation of an example endpoint device 500 to implement examples disclosed herein. In some examples, one(s) of the endpoint devices 116, 118, 120, 122 of FIG. 1 can be implemented by the endpoint device 500 of FIG. 5. Further depicted in the illustrated example of FIG. 5 is an example electronic device 504 and an example cloud server 506. In some examples, one(s) of the electronic devices 102, 104, 106, 108, 110, 112, 114 of FIG. 1 and/or one(s) of the electronic devices 402 of FIG. 4 can be implemented by the electronic device 504 of FIG. 5. In some examples, the cloud server 126 of FIG. 1 can be implemented by the cloud server 506 of FIG. 5.

The endpoint device 502 of the illustrated example includes an example operating system (OS) 508, an example device configuration agent 510, first example functions 512, second example functions 514, and an example user interface 516. In some examples, the device configuration agents 140A-D of FIG. 1 can be implemented by the device configuration agent 510 of FIG. 5. In some examples, the device configuration agent circuitry 300 of FIG. 3 can implement the device configuration agent 510 of FIG. 5. For example, the device configuration agent circuitry 510 can execute machine-readable instructions to implement and/or instantiate the device configuration agent 502 of FIG. 5. The first functions 512 of the illustrated example are delta functions. For example, the first functions 512 can be delta functions corresponding to functions having a first level of sophistication, such as data collection and/or data pre-processing. The second functions 514 of the illustrated example are sigma functions. For example, the second functions 514 can be sigma functions corresponding to functions having a second level of sophistication greater than the first level of sophistication, such as by executing machine-learning model(s) on the collected data, generating recommendations for automation and/or control of the electronic device 504, etc., and/or any combination(s) thereof.

In some examples, a first level of sophistication can refer to a first threshold number of machine-readable instructions that can be executed and/or instantiated to implement the first functions 512. In some examples, the first level of sophistication can refer to a first threshold number of hardware (e.g., a number of processor gigahertz, a number of memory gigabytes, a number of HDD gigabytes/terabytes, etc.) and/or software resources (e.g., a number of APIs, a number of services, a number of DLLs, etc.) to be utilized for execution and/or instantiation of the first functions 512.

In some examples, a second level of sophistication can refer to a second threshold number of machine-readable instructions that can be executed and/or instantiated to implement the second functions 514. In some examples, the second level of sophistication can refer to a second threshold number of hardware (e.g., a number of processor gigahertz, a number of memory gigabytes, a number of HDD gigabytes/terabytes, etc.) and/or software resources (e.g., a number of APIs, a number of services, a number of DLLs, etc.) to be utilized for execution and/or instantiation of the second functions 514. In some examples, the second threshold number of machine-readable instructions can be greater than the first threshold number of machine-readable instructions. In some examples, the second threshold number of hardware and/or software resources can be greater than the first threshold number of hardware and/or software resources.

The device configuration agent 510, the first functions 512, the second functions 514, and the user interface 516 can be executed, hosted, and/or instantiated by the OS 508. For example, the device configuration agent 510 can carry out and/or perform orchestration, service connector, and container runtime workloads. For example, the device configuration agent 510 can execute orchestration tasks to handle workload sequencing, task ordering, etc., to implement device connectivity between the electronic device 504 and the endpoint device 502. In some examples, the device configuration agent 510 can execute container runtime tasks to instantiate a container runtime environment to execute containers.

The cloud server 506 of the illustrated example includes an example container repository 518, an example independent hardware vendor (IHV) interface and/or landing page 520, and an example device configuration service 522. In some examples, the device configuration service 408 of FIG. 4 can be implemented by and/or correspond to the device configuration service 522 of FIG. 5.

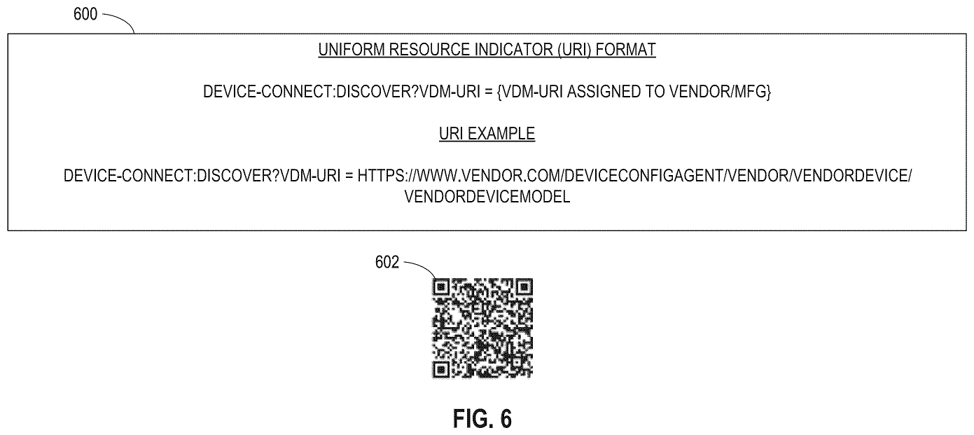

In some examples, the device configuration agent 510 can execute service connector tasks to request containers, services, etc., from the cloud server 506 that correspond to a URI of the electronic device 504. An example implementation of a URI is depicted in the illustrated example of FIG. 6.

Turning to the illustrated example of FIG. 6, a URI as disclosed herein can be based on an example URI format 600 as depicted in FIG. 6. The URI format 600 of FIG. 6 depicts an example encapsulation mechanism or schema that provides at least one of (1) a mechanism to launch an application and/or send data to a running application or (2) the target URI that the device configuration agent 510 is to reach out to for retrieving the first functions 512 and/or other information from the device configuration service 522. For example, a URI of the electronic device 504 can be generated by the device configuration service 522, and/or, more generally, the cloud server 506 of FIG. 5. For example, the URI of the electronic device 504 can be DEVICE-CONNECT:DISCOVER?VDM-URI=HTTPS://WWW.VENDOR.COM/DEVICECONFIGAGENT/VENDOR/VENDORDEVICE/VENDORDEVICEMODEL. For example, the device configuration agent 510 can execute a discovery service via the service connector task(s) that identifies the service (DEVICE-CONNECT:DISCOVER?VDM-URI) from a message broadcast from the electronic device 504. In some examples, an encapsulated URI as disclosed herein can be generated by appending and/or adding a data wrapper to a URI to generate the encapsulated URI. For example, the URI (HTTPS://WWW.VENDOR.COM/DEVICECONFIGAGENT/VENDOR/VENDORDEVICE/VENDORDEVICEMODEL) can be appended with a data wrapper (DEVICE-CONNECT:DISCOVER?VDM-URI=) to generate the encapsulated URI.

In some examples, the device configuration agent 510 can generate the user interface 516 as a user portal and/or dashboard to request authorization from a user whether to connect to the electronic device 504. After obtaining the authorization from the user, the device configuration agent 510 via the orchestration task(s) can execute the URI (HTTPS://WWW.VENDOR.COM/DEVICECONFIGAGENT/VENDOR/VENDORDEVICE/VENDORDEVICEMODEL) to request the first functions 512 that correspond to the URI from the container repository 518. Alternatively, the device configuration agent 510 may discover the electronic device 504 by listening to a fixed registered IP port (e.g., HTTP://127.0.0.1:30042/DISCOVER?VDM-URI=HTTPS://WWW.VENDOR.COM/DEVICECONFIGAGENT/VENDOR/VENDORDEVICE/VENDORDEVICEMODEL, where 30042 is the fixed registered IP port).

In some examples, the endpoint device 502 can capture an example QR code 602, which is depicted in FIG. 6, on and/or associated with the electronic device 504. The device configuration agent 510 can determine that the QR code 602 corresponds to the URI (HTTPS://WWW.VENDOR.COM/DEVICECONFIGAGENT/VENDOR/VENDORDEVICE/VENDORDEVICEMODEL) and proceed as described above. In example operation, after detection of the URI scheme depicted in FIG. 6 by the device configuration agent 510, the OS 508, a QR code scanner, etc., then an application, such as the device configuration application 404 of FIG. 4, can be launched to complete the connection to the electronic device 504.

Some QR code generators and readers consider a non-HTTP link such as “mailto:” or “VDM-URI” to be an error and do not work as intended. In some examples, to overcome this limitation and improve cross-reader compatibility, the device configuration service 522 can execute and/or instantiate a uniform resource locator (URL) shortening web service (e.g., a URL shortening web service as provided by TinyURL, LLC) to create a link (e.g., an Internet or web accessible link) that converts the unconventional URL into a generally acceptable URL.

Turning back to the illustrated example of FIG. 5, in an example operation, the electronic device 504 provides a URI, which identifies the electronic device 504, to the endpoint device 502 via the device configuration agent 510. After receiving the URI, the device configuration agent 510 executes orchestration task(s) to request container(s) from the container repository 518 that correspond to the URI. The device configuration agent 510 can cause the endpoint device 502 to connect and/or establish a connection with the electronic device 504 after obtaining the container(s). After the electronic device 504 connects to the endpoint device 502 and the device configuration agent 510 has downloaded the first functions 512, which can be implemented by execution and/or instantiation of the container(s), the device configuration agent 510 establishes a communication channel with the electronic device 504. For example, the device configuration agent 502 executes service connector task(s) to collect telemetry data, sensor data, etc., from the electronic device 504 and provide the collected data to the first functions 512.

In example operation, the first functions 512 can process (e.g., pre-process) the collected data by extracting data of interest (e.g., data portions) from the collected data, decrypting/encrypting the collected data, converting the collected data from a first data format to a second data format, etc., and/or any combination(s) thereof. In some examples, the first functions 512 can output data to a backend server, such as the cloud server 506 using any proprietary and/or standard data format.

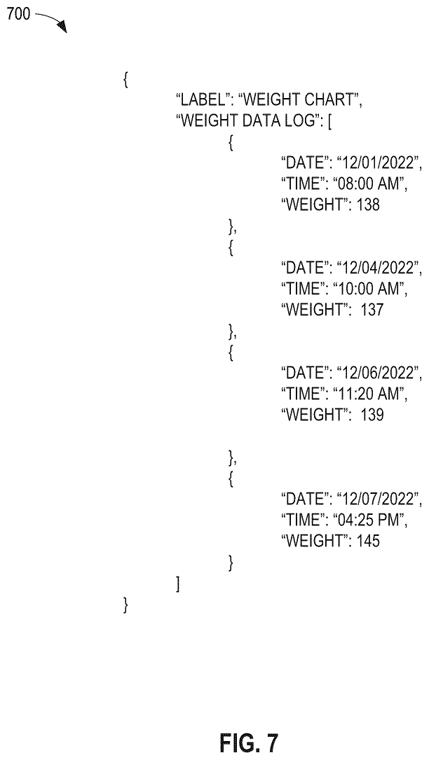

In some examples, the first functions 512 can provide remote procedure call (RPC) and/or representational state transfer (REST) interfaces or APIs and expose data objects, such as JavaScript Object Notation (JSON) data objects, that are standardized for the specific category and/or type of the electronic device 504. A first example JSON data object 700 that can be exposed by the first functions 512, and/or, more generally, the endpoint device 502, is depicted in the illustrated example of FIG. 7.

Turning to the illustrated example of FIG. 7, the first JSON data object 700 depicts example data from a weight sensor, which can be included in a scale (e.g., a smart and/or electronic scale, an Internet-enabled scale, a bathroom-style scale, a weight appliance, etc.). For example, the electronic device 504 of FIG. 5 can be a smart scale that is communicatively coupled to the endpoint device 502 via the device configuration agent 510. In some examples, the smart scale can output data, such as timestamp and weight data associated with a user, to the first functions 512 via the device configuration agent 510 executing service connector tasks and/or container runtime tasks. Alternatively, the data depicted in the illustrated example of FIG. 7 may be represented, stored, and/or processed in any other data format.

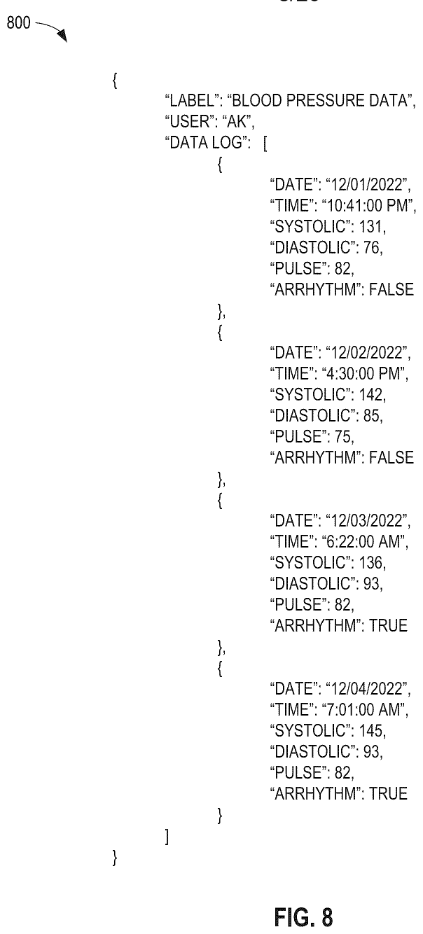

A second example JSON data object 800 that can be exposed by the first functions 512, and/or, more generally, the endpoint device 502, is depicted in the illustrated example of FIG. 8. Turning to the illustrated example of FIG. 8, the second JSON data object 800 depicts example data from a blood pressure sensor, which can be a standalone device and/or be included in another wearable device (e.g., a smartwatch, a fitness tracker, etc.). For example, the electronic device 504 of FIG. 5 can be a blood pressure sensor that is communicatively coupled to the endpoint device 502 via the device configuration agent 510. In some examples, the blood pressure sensor can output data, such as timestamp, blood pressure, pulse, and arrhythmia status data associated with a user, to the first functions 512 via the device configuration agent 510 executing service connector tasks and/or container runtime tasks. Alternatively, the data depicted in the illustrated example of FIG. 8 may be represented, stored, and/or processed in any other data format. By using such JSON data objects 700, 800, the second functions 514 can pull the data, information, etc., from several ones of the electronic device 504 (of the same or different type) and aggregate the data, information, etc., from the several ones of the electronic device 504.

Turning back to the illustrated example of FIG. 5, in example operation, the first functions 512 can output data (e.g., processed or pre-processed data) to the second functions 514. In some examples, the second functions 514 can execute and/or instantiate machine-learning model(s) using the data as model input(s) to generate model output(s), which can include recommendations of alerts and/or notifications to be presented to a user of the electronic device 504, automation and/or control commands to control the electronic device 504, etc., and/or any combination(s) thereof. For example, the second functions 514 can build additional intelligence, machine-learning model(s), predictive features, triggers, automation, self-correcting actions, etc., in the endpoint device 502.

By way of example, the first functions 512 can obtain personal vital health data (e.g., blood pressure, weight, body temperature, heart rate, etc.) from one(s) of the electronic device 504 and output the personal vital health data to the second functions 514 to be combined with data from other electronic devices, such as a sensor of a refrigerator or pantry and detection of food consumed. The second functions 514 can execute machine-learning model(s) on such data to generate output(s) such as food recommendations or diet suggestions specific to a user associated with the data.

By way of another example, the first functions 512 can obtain data from one(s) of the electronic device 504, which can be a light switch, a garage door sensor, a front door sensor, a camera, a sprinkler system, a motion sensor, etc. The first functions 512 can output the data to the second functions 514 to be aggregated and/or correlated. The second functions 514 can execute machine-learning model(s) on the aggregated/correlated data to learn and/or automate daily routines of a user associated with the electronic device 504 and/or augment the automation with other data (e.g., environmental data) such as weather data, sunset and/or sunrise times, etc. In some examples, the second functions 514 can be fetched from the cloud server 506 akin to the fetching of the first functions 512.

In some examples, the user interface 516 can be generated using the JSON data objects 700, 800 of FIGS. 7 and/or 8 from the first functions 512 and/or the second functions 514. The user interface 516 can be implemented by dynamic and/or adaptable user portals, dashboards, etc., to enhance the user experience of interacting with the electronic device 504.

While an example manner of implementing the cloud server 126 of FIG. 1 is illustrated in FIG. 5, one or more of the elements, processes, and/or devices illustrated in FIG. 5 may be combined, divided, re-arranged, omitted, eliminated, and/or implemented in any other way. Further, the example container repository 518, the example landing page 520, and/or the example device configuration service 522, and/or, more generally, the example cloud server 126 of FIG. 1, may be implemented by hardware alone or by hardware in combination with software and/or firmware. Thus, for example, any of the example container repository 518, the example landing page 520, and/or the example device configuration service 522, and/or, more generally, the example cloud server 126 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the cloud server 126 of FIG. 1 may include one or more elements, processes, and/or devices in addition to, or instead of, those illustrated in FIG. 5, and/or may include more than one of any or all of the illustrated elements, processes and devices.

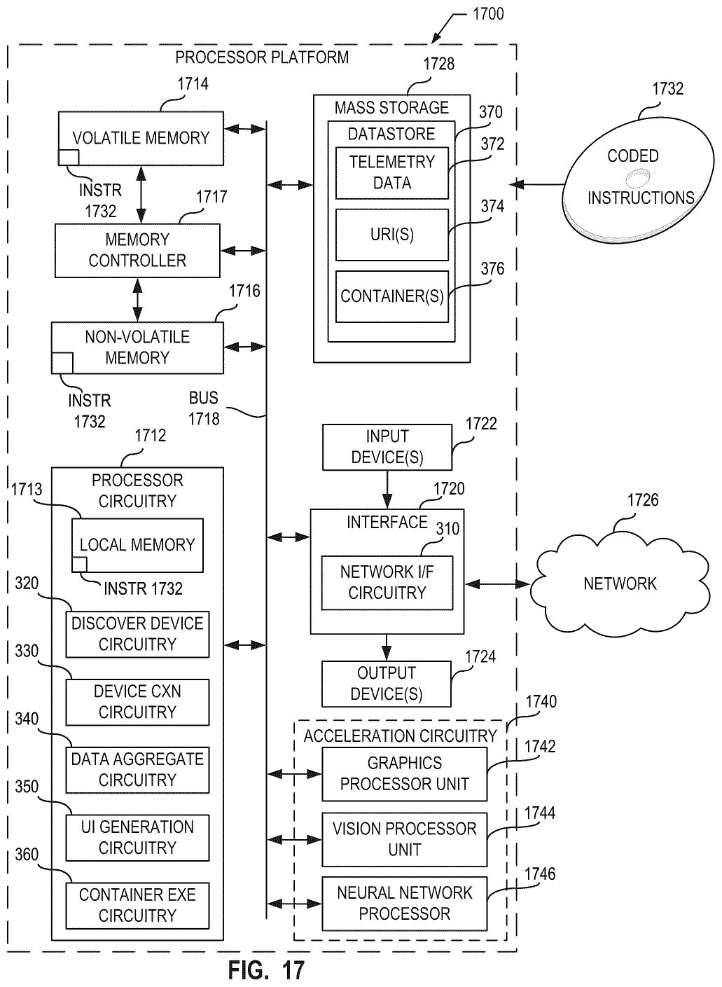

Flowcharts representative of example machine readable instructions, which may be executed to configure processor circuitry to implement the device configuration agent interface circuitry 200 of FIG. 2 and/or the device configuration agent circuitry 300 of FIG. 3, are shown in FIGS. 9-15. The machine readable instructions may be one or more executable programs or portion(s) of an executable program for execution by processor circuitry, such as the processor circuitry 1612 shown in the example processor platform 1600 discussed below in connection with FIG. 16, the processor circuitry 1712 shown in the example processor platform 1700 discussed below in connection with FIG. 17, and/or the example processor circuitry discussed below in connection with FIGS. 18 and/or 19. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 9-15, many other methods of implementing the example device configuration agent interface circuitry 200 of FIG. 2 and/or the example device configuration agent circuitry 300 of FIG. 3 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), SQL, Swift, etc.

As mentioned above, the example operations of FIGS. 9-15 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed and/or instantiated by processor circuitry to instantiate a container to execute a service based on data from an electronic device. The example machine readable instructions and/or the example operations 900 of FIG. 9 begin at block 902, at which the electronic devices 102, 104, 106, 108, 110, 112, 114 of FIG. 1 broadcast a message including a uniform resource indicator corresponding to an electronic device. For example, the network interface circuitry 210 (FIG. 2) of the second electronic device 104 of FIG. 1 can broadcast (e.g., unicast, multicast, etc.) a data message, which includes a URI (e.g., a URI based on the URI format 600 of FIG. 6) that identifies the second electronic device 104.

At block 904, the endpoint devices 116, 118, 120, 122 launch a user interface to display a request for authorization to connect to the electronic device. For example, the network interface circuitry 310 (FIG. 3) of the first endpoint device 116 can receive the broadcasted message from the second electronic device 104. In some examples, the discover device circuitry 320 (FIG. 3) of the first endpoint device 116 can identify the URI in the broadcasted message. In some examples, the user interface generation circuitry 350 (FIG. 3) of the first endpoint device 116 can generate and/or launch a user interface to display a request for authorization to connect to the second electronic device 104.

At block 906, the endpoint devices 116, 118, 120, 122 instantiate a container to execute a service based on data obtained from the electronic device. For example, the network interface circuitry 310 of the first endpoint device 116 can transmit the URI to the cloud server 126 in exchange for a container corresponding to the URI. In some examples, the container execution circuitry 360 (FIG. 3) can execute and/or instantiate the container from the cloud server 126 to execute a service, such as a machine-learning model, on telemetry and/or sensor data from second electronic device 104. For example, the container execution circuitry 360 can execute and/or instantiate a machine-learning service on temperature data from the second electronic device 104 to learn a user's behavior in connection with heating and/or cooling a residence of the user associated with the second electronic device 104. For example, the container execution circuitry 360 can execute and/or instantiate a machine-learning service to generate a recommendation to change a temperature setting of a home thermostat, to identify that an appliance such as an oven has been left running for an extended period of time, to turn off the seventh electronic device 114 after a determination that the user is sleeping and left the seventh electronic device 114 on, etc., and/or any combination(s) thereof. After instantiating a container to execute a service based on data obtained from the electronic device at block 906, the example machine readable instructions and/or the example operations 900 of FIG. 9 conclude.

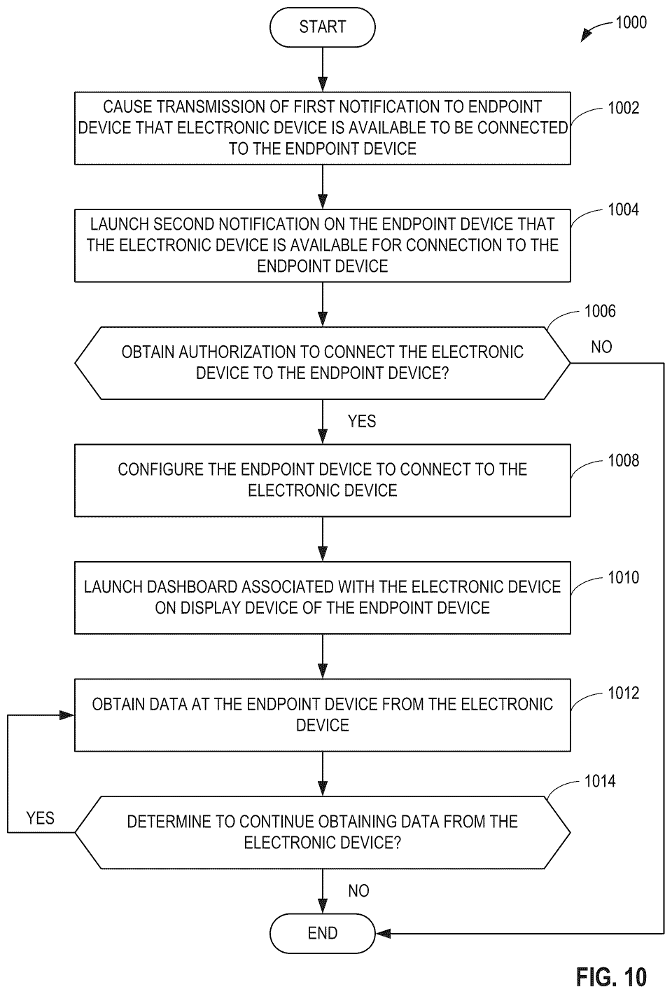

FIG. 10 is a flowchart representative of example machine readable instructions and/or example operations 1000 that may be executed and/or instantiated by processor circuitry to connect a first electronic device to a second electronic device. The example machine readable instructions and/or the example operations 1000 of FIG. 10 begin at block 1002, at which the device configuration agent interface circuitry 200 causes transmission of a first notification to an endpoint device that an electronic device is available to be connected to the endpoint device. For example, the network interface circuitry 210 (FIG. 2) of the electronic device 504 of FIG. 5 can transmit a message, which can include a URI that corresponds to the electronic device 504, to the endpoint device 502.

At block 1004, the device configuration agent circuitry 300 launches a second notification on the endpoint device that the electronic device is available for connection to the endpoint device. For example, the user interface generation circuitry 350 (FIG. 3) can generate and/or launch the user interface 516 of FIG. 5 to present a notification to a user that the electronic device 504 is available and/or ready to be connected to the endpoint device 502.

At block 1006, the device configuration agent circuitry 300 determines whether an authorization to connect the electronic device to the endpoint device is obtained. For example, the user interface generation circuitry 350 can determine whether a user clicked a, touched, tapped, and/or otherwise interacted with a button or other icon on the user interface 516 to provide the authorization to the endpoint device 502 to establish a connection to the electronic device 504.

If, at block 1006, the device configuration agent circuitry 300 determines that an authorization to connect the electronic device to the endpoint device is not obtained, the example machine readable instructions and/or the example operations 1000 of FIG. 10 conclude. Otherwise, control proceeds to block 1008.

At block 1008, the device configuration agent circuitry 300 configures the endpoint device to connect to the electronic device. For example, the device connection circuitry 330 (FIG. 3) can obtain the container(s) 376, which correspond to the URI of the electronic device 504, from the container repository 518 of the cloud server 506 of FIG. 5. In some examples, the device connection circuitry 330 can install, run, execute, and/or instantiate the container(s) 376 to cause the endpoint device 502 to be configured to establish a communication channel to the electronic device 504.

At block 1010, the device configuration agent circuitry 300 launches a dashboard associated with the electronic device on a display device of the endpoint device. For example, the user interface generation circuitry 350 can generate the user interface 516 based on data objects, such as the JSON data objects 700, 800 of FIGS. 7 and/or 8, and launch and/or present the user interface 516 to a user.

At block 1012, the device configuration agent circuitry 300 obtains data at the endpoint device from the electronic device. For example, the data aggregation circuitry 340 (FIG. 3) can obtain data from the electronic device 504. In some examples, the data aggregation circuitry 340 can execute and/or instantiate the first functions 512, the second functions 514, etc., and/or any combination(s) thereof based on the obtained data. For example, the data aggregation circuitry 340 can execute and/or instantiate a machine-learning service on the aggregated/correlated data to generate a useful output, such as a recommendation to control and/or automate the electronic device 504 in a specified manner. In some examples, the recommendation can be implemented by information displayed on a display device that describes why the recommendation is being provided and/or how the recommendation is beneficial to the user.

At block 1014, the device configuration agent circuitry 300 determines whether to continue obtaining data from the electronic device. For example, the network interface circuitry 310 (FIG. 3) can determine whether the endpoint device 502 is to continue obtaining data from the electronic device 504. If, at block 1014, the device configuration agent circuitry 300 determines to continue obtaining data from the electronic device, control returns to block 1012. Otherwise, the example machine readable instructions and/or the example operations 1000 of FIG. 10 conclude.

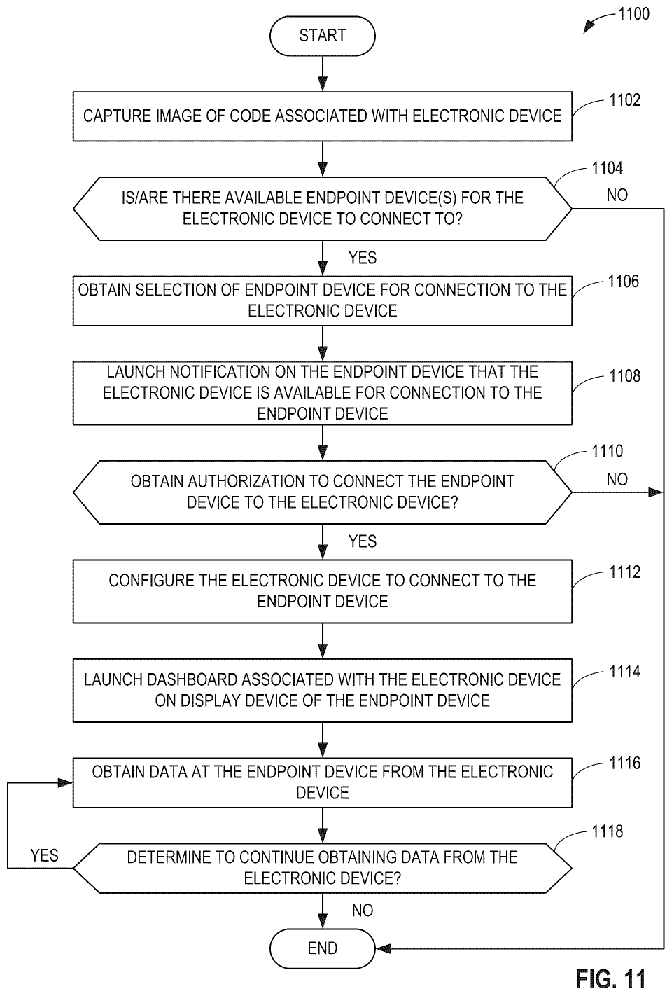

FIG. 11 is a flowchart representative of example machine readable instructions and/or example operations 1100 that may be executed and/or instantiated by processor circuitry to connect an electronic device to an endpoint device. The example machine readable instructions and/or the example operations 1100 of FIG. 11 begin at block 1102, at which the first endpoint device 116 (or a different device) captures an image of a code associated with an electronic device. For example, the sensor interface circuitry 220 (FIG. 2) of the first endpoint device 116 can capture, with a sensor such as a camera, of the fifth code 128E on the fifth electronic device 110 of FIG. 1. In some examples, the sensor interface circuitry 220 can determine that the fifth code 128E is representative of a URI that identifies and/or corresponds to the fifth electronic device 110.

At block 1104, the device configuration agent interface circuitry 200 determines whether there is/are available endpoint device(s) for the electronic device to connect to. For example, the discover device circuitry 250 (FIG. 2) of the first endpoint device 116 can determine that the fifth electronic device 110 can connect to one(s) of the endpoint devices 116, 118, 120, 122 and/or one(s) of the electronic devices 102, 104, 106, 108, 110, 112, 114 of FIG. 1 associated with the network 124 of FIG. 1 by execution and/or instantiation of one or more discovery protocols as disclosed herein.

If, at block 1104, the device configuration agent interface circuitry 200 determines that there are no available endpoint device(s) for the electronic device to connect to, the example machine-readable instructions and/or the example operations 1100 of FIG. 11 conclude. If, at block 1104, the device configuration agent interface circuitry 200 determines that there is/are available endpoint device(s) for the electronic device to connect to, control proceeds to block 1106.

At block 1106, the device configuration agent interface circuitry 200 obtains a selection of an endpoint device for connection to the electronic device. For example, the user interface generation circuitry 260 (FIG. 2) of the first endpoint device can generate, launch, and/or present a GUI to prompt a selection from a user. In some examples, the device configuration agent interface circuitry 240 (FIG. 2) of the first endpoint device 116 can obtain a selection from a user, such as via a GUI presented by a display device of the first endpoint device 116, to connect the fifth electronic device 110 to the fourth endpoint device 122 (e.g., to stream, cast, and/or sling media accessible by the fifth electronic device 110 on the fourth endpoint device 122).

At block 1108, the device configuration agent circuitry 300 launches a notification on the endpoint device that the electronic device is available for connection to the endpoint device. For example, the network interface circuitry 310 (FIG. 3) of the first endpoint device 116 can output the URI to the network interface circuitry 310 of the fourth endpoint device 122. After receiving the URI at the fourth endpoint device 122, the user interface generation circuitry 350 (FIG. 3) on the fourth endpoint device 122 can generate, launch, and/or present a GUI to a user to request authorization to connect the fourth endpoint device 122 to the fifth electronic device 110.

At block 1110, the device configuration agent circuitry 300 determines whether authorization is obtained to connect the endpoint device to the electronic device. For example, the user interface generation circuitry 350 of the fourth endpoint device 122 can determine that a user accepted the request for authorization to connect the fourth endpoint device 122 to the fifth electronic device 110.

If, at block 1110, the device configuration agent circuitry 300 determines that authorization is not obtained to connect the endpoint device to the electronic device, the example machine-readable instructions and/or the example operations 1100 of FIG. 11 conclude. If, at block 1110, the device configuration agent circuitry 300 determines that authorization is obtained to connect the endpoint device to the electronic device, control proceeds to block 1112.

At block 1112, the device configuration agent circuitry 300 configures the electronic device to connect to the endpoint device. For example, the device connection circuitry 330 (FIG. 3) can obtain the container(s) 376 from the cloud server 126 that correspond to the URI of the fifth electronic device 110. In some examples, the container execution circuitry 360 (FIG. 3) of the fourth endpoint device 122 can execute and/or instantiate the container(s) 376 to execute service(s), software, etc., to establish a communication channel between the fifth electronic device 110 and the fourth endpoint device 122.

At block 1114, the device configuration agent circuitry 300 launches a dashboard associated with the electronic device on a display device of the endpoint device. For example, the user interface generation circuitry 350 of the fourth endpoint device 122 can generate, launch, and/or present a dashboard GUI to present data associated with the fifth electronic device 110. In some examples, the dashboard GUI can be implemented as video, such as streaming media, that can be consumed and/or watched by a user of the fourth endpoint device 122.

At block 1116, the device configuration agent circuitry 300 obtains data at the endpoint device from the electronic device. For example, the data aggregation circuitry 340 (FIG. 3) of the fourth endpoint device 122 can obtain data (e.g., sensor data, telemetry data, media, etc.) from the fifth electronic device 110.

At block 1118, the device configuration agent circuitry 300 determines whether to continue obtaining data from the electronic device. For example, the network interface circuitry 310 of the fourth endpoint device 122 can determine whether to continue obtaining data from the fifth electronic device 110.

If, at block 1118, the device configuration agent circuitry 300 determines to continue obtaining data from the electronic device, control returns to block 1116. Otherwise, the example machine-readable instructions and/or the example operations 1100 conclude.

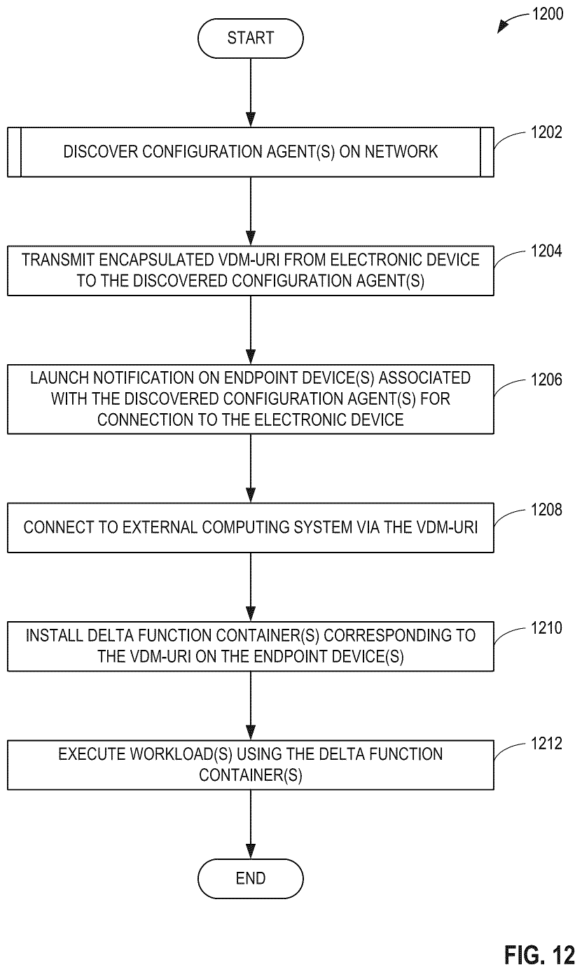

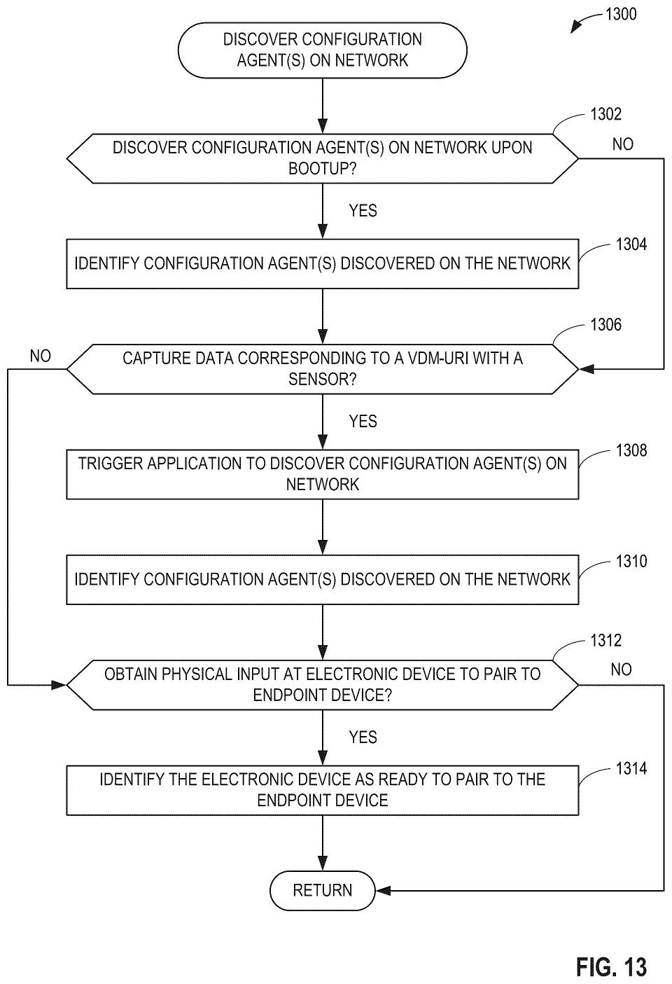

FIG. 12 is a flowchart representative of example machine readable instructions and/or example operations 1200 that may be executed and/or instantiated by processor circuitry to execute a workload using a container. The example machine readable instructions and/or the example operations 1200 of FIG. 12 begin at block 1202, at which the device configuration agent interface circuitry 200 (FIG. 2) discovers configuration agent(s) on a network. For example, the discover device circuitry 250 (FIG. 2) of the fourth electronic device 108 of FIG. 1 can discover one(s) of the device configuration agents 140A-D of FIG. 1 associated with the network 124 of FIG. 1. Example machine-readable instructions and/or example operations that may be executed and/or instantiated to implement block 1202 are described below in connection with FIG. 13.

At block 1204, the device configuration agent interface circuitry 200 transmits an encapsulated VDM-URI from an electronic device to the discovered configuration agent(s). For example, the network interface circuitry 210 (FIG. 2) can transmit a VDM-URI that corresponds to the fourth electronic device 108 to one(s) of the device configuration agents 140A-D of FIG. 1.

At block 1206, the device configuration agent circuitry 300 (FIG. 3) launches a notification on endpoint device(s) associated with the discovered configuration agent(s) for connection to the electronic device. For example, the user interface generation circuitry 350 (FIG. 3) of the second endpoint device 118 can generate, launch, and/or present a notification, based on the VDM-URI, on a display device of the second endpoint device 118 representative of a request for connection to the fourth electronic device 108.

At block 1208, the device configuration agent circuitry 300 connects to an external computing system via the VDM-URI. For example, the network interface circuitry 310 (FIG. 3) of the second endpoint device 118 can access a network location, path, webserver, etc., corresponding to the VDM-URI. In some examples, the network interface circuitry 310 can access the cloud server 126 in response to accessing the VDM-URI.

At block 1210, the device configuration agent circuitry 300 installs, downloads, and/or otherwise accesses delta function container(s) corresponding to the VDM-URI on the endpoint device(s). For example, the network interface circuitry 310 of the second endpoint device 118 can obtain the container(s) 376, which correspond to the VDM-URI, from the cloud server 126. In some examples, the container execution circuitry 360 (FIG. 3) of the second endpoint device 118 can install, configure, and/or execute the container(s) 376 in a container execution environment of the second endpoint device 118.

At block 1212, the device configuration agent circuitry 300 executes workload(s) using the delta function container(s). For example, the container execution circuitry 360 of the second endpoint device 118 can execute the container(s) 376 using data from the fourth electronic device 108 as input(s) to generate output(s), which can include data to print onto paper, AI/ML output(s), etc. After executing workload(s) using the delta function container(s) at block 1212, the example machine-readable instructions and/or the example operations 1200 of FIG. 12 conclude.

FIG. 13 is a flowchart representative of example machine readable instructions and/or example operations 1300 that may be executed and/or instantiated by processor circuitry to discover configuration agent(s) on a network. The example machine readable instructions and/or the example operations 1300 of FIG. 13 can be executed and/or instantiated to implement block 1202 of the example machine readable instructions and/or the example operations 1200 of FIG. 12.

The example machine readable instructions and/or the example operations 1300 of FIG. 13 begin at block 1302, at which the device configuration agent interface circuitry 200 (FIG. 2) determines whether configuration agent(s) is/are discovered on a network upon bootup. For example, the discover device circuitry 250 (FIG. 2) of the third electronic device 106 of FIG. 1 can discover one(s) of the device configuration agents 140A-C of FIG. 1 after being powered, turned on, initialized, booted up, etc.

If, at block 1302, the configuration interface circuitry 200 determines that there is/are no configuration agent(s) discovered on a network upon bootup, control proceeds to block 1306. Otherwise, control proceeds to block 1304.

At block 1304, the device configuration agent interface circuitry 200 identifies configuration agent(s) discovered on the network. For example, the device configuration agent interface circuitry 240 (FIG. 2) of the third electronic device 106 can identify the first endpoint device 116 as discoverable on the network 124 of FIG. 1.

At block 1306, the device configuration agent circuitry 300 determines whether data corresponding to a VDM-URI is captured with a sensor. For example, the discover device circuitry 320 (FIG. 3) of the first endpoint device 116 can capture an image of the first code 128A with a camera of the first endpoint device 116.

If, at block 1306, the device configuration agent circuitry 300 determines that data corresponding to a VDM-URI is not captured with a sensor, control proceeds to block 1312. Otherwise, control proceeds to block 1308.

At block 1308, the device configuration agent circuitry 300 triggers an application to discover configuration agent(s) on network. For example, the discover device circuitry 320 of the first endpoint device 116 can trigger an application, a service, etc., to discover one(s) of the device configuration agents 140A-D via one or more discovery protocols.

At block 1310, the device configuration agent circuitry 300 identifies configuration agent(s) discovered on the network. For example, the discover device circuitry 320 of the first endpoint device 116 can identify one(s) of the device configuration agents 140A-D as available for connection to the third electronic device 106.

At block 1312, the device configuration agent interface circuitry 200 determines whether a physical input at an electronic device to pair to an endpoint device is obtained. For example, the discover device circuitry 250 of the third electronic device 106 can determine that a button (e.g., a physical button, a button on a touchscreen, etc.) or any other physical actuation is received and/or sensed that is indicative of a user request to pair and/or connect the third electronic device 106 to one(s) of the device configuration agents 140A-D of FIG. 1. In some examples, a user can indicate a request to pair and/or connect a device using a visual (e.g., gesture) and/or audio (e.g., speech) command.

If, at block 1312, the device configuration agent interface circuitry 200 determines that a physical input at an electronic device to pair to an endpoint device is not obtained, the example machine-readable instructions and/or the example operations 1300 of FIG. 13 conclude. For example, the machine-readable instructions and/or the example operations 1300 of FIG. 13 can return to block 1204 of the machine-readable instructions and/or the example operations 1200 of FIG. 12.

If, at block 1312, the device configuration agent interface circuitry 200 determines that a physical input at an electronic device to pair to an endpoint device is obtained, control proceeds to block 1314.

At block 1314, the device configuration agent interface circuitry 200 identifies the electronic device as ready to pair to the endpoint device. For example, the device configuration agent interface circuitry 240 (FIG. 2) of the third electronic device 106 can broadcast a URI that corresponds to the third electronic device 106 to one(s) of the device configuration agents 140A-D of FIG. 1. After identifying the electronic device as ready to pair to the endpoint device, the example machine-readable instructions and/or the example operations 1300 of FIG. 13 conclude.

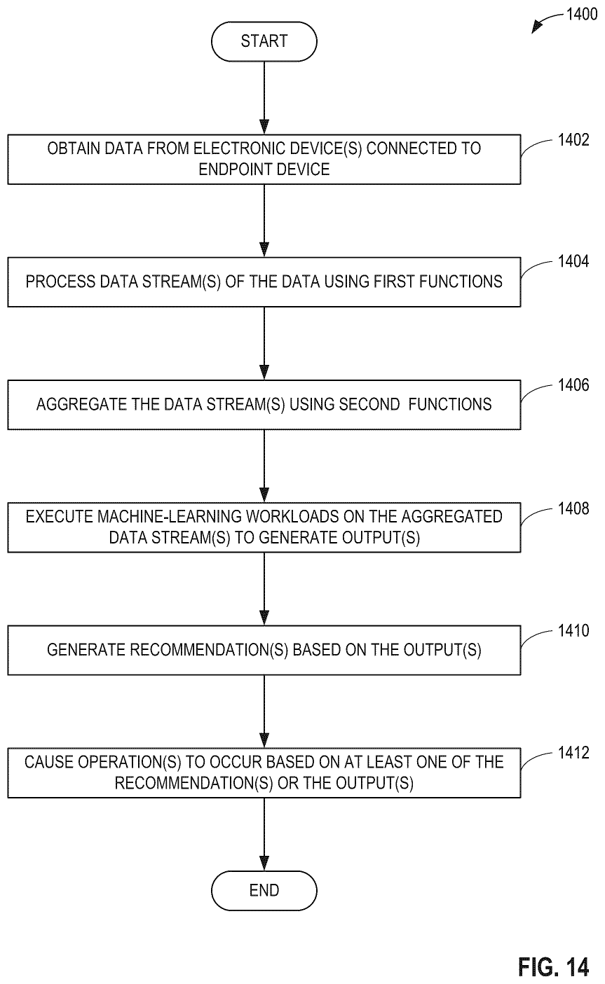

FIG. 14 is a flowchart representative of example machine readable instructions and/or example operations 1400 that may be executed and/or instantiated by processor circuitry to cause operation(s) to occur based on at least one of recommendation(s) or output(s) from a machine-learning model. The example machine readable instructions and/or the example operations 1400 of FIG. 14 begin at block 1402, at which the device configuration agent circuitry 300 (FIG. 3) obtains data from electronic device(s) connected to endpoint device. For example, the network interface circuitry 310 (FIG. 3) of the endpoint device 502 of FIG. 5 can obtain data from the electronic device 504 of FIG. 5.

At block 1404, the device configuration agent circuitry 300 processes data stream(s) of the data using first functions. For example, the data aggregation circuitry 340 can process stream(s) of data obtained from the electronic device 504 using the first functions 512 of FIG. 5. In some examples, the data aggregation circuitry 340 can process the stream(s) of data by decrypting/encrypting the data, extracting portion(s) of interest from the data, identifying a source of the data from a header or header data of the stream(s), etc.

At block 1406, the device configuration agent circuitry 300 aggregates the data stream(s) using third functions. For example, the data aggregation circuitry 340 can combine, reorganize, rearrange, and/or aggregate the processed stream(s) of data using the second functions 514 of FIG. 5. In some examples, the data aggregation circuitry 340 can aggregate the processed stream(s) of data to generate recommendations based on data from a plurality of devices instead of a single or a few number of devices.

At block 1408, the device configuration agent circuitry 300 executes machine-learning workloads on the aggregated data stream(s) to generate output(s). For example, the container execution circuitry 360 (FIG. 3) can execute and/or instantiate the container(s) 376 (FIG. 3) in the container runtime of the device configuration agent 502 to implement machine-learning model(s) using the aggregated data stream(s) as machine-learning input(s) to generate machine-learning output(s). As described above, the machine-learning model(s) may be trained to generate a recommendation to automate and/or control one(s) of the electronic devices 102, 104, 106, 108, 110, 112, 114 based on user behavior represented by obtained data from such electronic device(s).

At block 1410, the device configuration agent circuitry 300 generates recommendation(s) based on the output(s). For example, the container execution circuitry 360 can execute and/or instantiate the container(s) 376 to generate the machine-learning output(s), which can include recommended settings and/or mode(s) of operation to configure the electronic device 504, automation and/or control commands to control the electronic device 504, generate recommendation(s) to change behavior(s) in a user associated with the electronic device 504, etc., and/or any combination(s) thereof. In some examples, the container execution circuitry 260 can execute and/or instantiate the container(s) 376 to generate information related to the generated recommendations (e.g., why the recommendation was generated, results of implementing the recommendation, etc.).

At block 1412, the device configuration agent circuitry 300 causes operation(s) to occur based on at least one of the recommendation(s), information related to the recommendation(s), and/or the output(s). For example, the network interface circuitry 310 can cause transmission of automation and/or control commands to change operation and/or control operation of the electronic device 504. In some examples, the network interface circuitry 310 can transmit the recommendation(s) to the electronic device 504 for presentation to a user to affect and/or change behavior thereof. After causing operation(s) to occur based on at least one of the recommendation(s) or the output(s) at block 1412, the example machine-readable instructions and/or the example operations 1400 of FIG. 14 conclude.

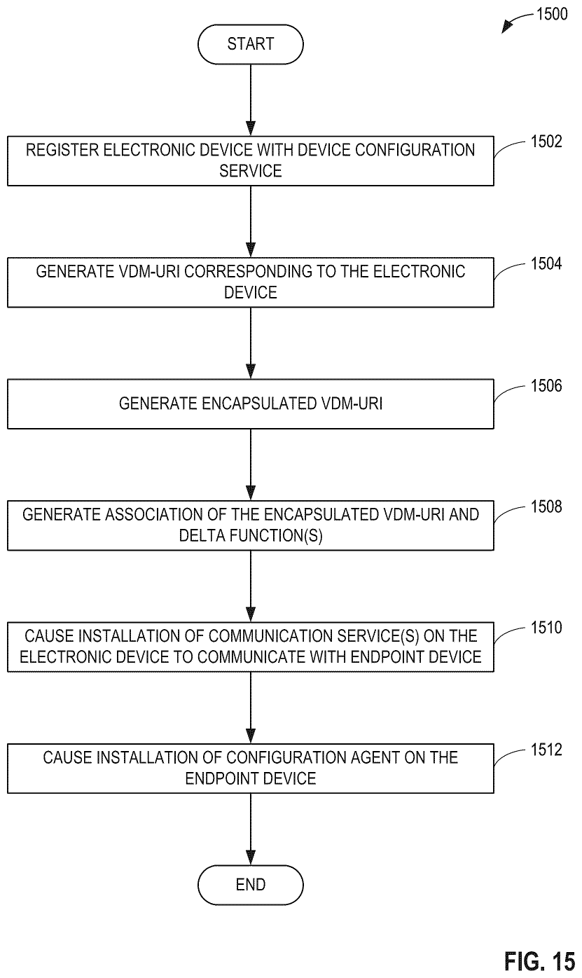

FIG. 15 is a flowchart representative of example machine readable instructions and/or example operations 1500 that may be executed and/or instantiated by processor circuitry to implement an example cloud service for device connectivity registration. The example machine readable instructions and/or the example operations 1500 of FIG. 15 begin at block 1502, at which the cloud server 126 registers an electronic device with a device configuration service. For example, the cloud server 506 of FIG. 5 can register the electronic device 504 of FIG. 5, a manufacturer and/or vendor of the electronic device 504, etc., with the device configuration service 522 of FIG. 5.

At block 1504, the cloud server 126 generates a VDM-URI corresponding to the electronic device. For example, the device configuration service 522 can generate a VDM-URI based on the URI format 600 of FIG. 6. As described above, the VDM-URI includes information that provides the endpoint devices 116, 118, 120, 122 a location (e.g., a web location, a network location, etc.) to access the container(s) 376 that correspond to the electronic device 504.

At block 1506, the cloud server 126 generates an encapsulated VDM-URI. For example, the configuration service 522 can generate an encapsulated VDM-URI based on the URI format 600 of FIG. 6. As described above, the encapsulated VDM-URI includes information that the endpoint devices 116, 118, 120, 122 can use to determine that a source of the encapsulated VDM-URI is initiating and/or executing a device connectivity operation.

At block 1508, the cloud server 126 generates an association of the encapsulated VDM-URI and delta function(s). For example, the device configuration service 522 can generate a data association, a mapping, etc., of the encapsulated VDM-URI and delta functions, such as the first functions 512 of FIG. 5, in the container repository 518 of FIG. 5. In some examples, the device configuration service 522 generates the data association, the mapping, etc., so that upon receipt of the encapsulated VDM-URI from the endpoint device 502, the device configuration service 522 can identify the corresponding containers in the container repository 518.

At block 1510, the cloud server 126 causes installation of communication service(s) on the electronic device to communicate with endpoint device. For example, the cloud server 126 can cause transmission of the device configuration agent interfaces 130A-G to one(s) of the electronic devices 102, 104, 106, 108, 110, 112, 114 for installation and/or subsequent execution.

At block 1512, the cloud server 126 causes installation of a configuration agent on the endpoint device. For example, the cloud server 126 can cause transmission of the device configuration agents 140A-D to one(s) of the endpoint devices 116, 118, 120, 122 for installation. After causing installation of a configuration agent on the endpoint device at block 1512, the example machine-readable instructions and/or the example operations 1500 of FIG. 15 conclude.

FIG. 16 is a block diagram of an example processor platform 1600 structured to execute and/or instantiate the example machine readable instructions and/or the example operations of FIGS. 9-15 to implement the example device configuration agent interface circuitry 200 of FIG. 2. The processor platform 1600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1600 of the illustrated example includes processor circuitry 1612. The processor circuitry 1612 of the illustrated example is hardware. For example, the processor circuitry 1612 can be implemented by one or more integrated circuits, logic circuits, FPGAs, microprocessors, CPUs, GPUs, DSPs, and/or microcontrollers from any desired family or manufacturer. The processor circuitry 1612 may be implemented by one or more semiconductor based (e.g., silicon based) devices. In this example, the processor circuitry 1612 implements the application interface circuitry 230 (identified by APPLICATION I/F CIRCUITRY), the device configuration agent interface circuitry 240 (identified by DCA I/F CIRCUITRY), the discover device circuitry 250, and the user interface generation circuitry 260 (identified by UI GENERATION CIRCUITRY) of FIG. 2.

The processor circuitry 1612 of the illustrated example includes a local memory 1613 (e.g., a cache, registers, etc.). The processor circuitry 1612 of the illustrated example is in communication with a main memory including a volatile memory 1614 and a non-volatile memory 1616 by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617.

The processor platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1620 implements the network interface circuitry 210 (identified by NETWORK I/F CIRCUITRY) and the sensor interface circuitry 220 (identified by SENSOR I/F CIRCUITRY) of FIG. 2.

In the illustrated example, one or more input devices 1622 are connected to the interface circuitry 1620. The input device(s) 1622 permit(s) a user to enter data and/or commands into the processor circuitry 1612. The input device(s) 1622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1600 of the illustrated example also includes one or more mass storage devices 1628 to store software and/or data. Examples of such mass storage devices 1628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 1628 implement the datastore 270, the sensor data 272, the code(s) 274, and the URI(s) 276 of FIG. 2.

The machine readable instructions 1632, which may be implemented by the machine readable instructions of FIGS. 9-15, may be stored in the mass storage device 1628, in the volatile memory 1614, in the non-volatile memory 1616, and/or on a removable non-transitory computer readable storage medium such as a CD or DVD.

The processor platform 1600 of the illustrated example of FIG. 16 includes example acceleration circuitry 1640, which includes an example graphics processing unit (GPU) 1642, an example vision processing unit (VPU) 1644, and an example neural network processor 1646. In this example, the GPU 1642, the VPU 1644, and the neural network processor 1646 are in communication with different hardware of the processor platform 1600, such as the volatile memory 1614, the non-volatile memory 1616, etc., via the bus 1618. In this example, the neural network processor 1646 may be implemented by one or more integrated circuits, logic circuits, microprocessors, GPUs, DSPs, or controllers from any desired family or manufacturer that can be used to execute an AI model, such as a neural network. In some examples, one or more of the application interface circuitry 230, the device configuration agent interface circuitry 240, the discover device circuitry 250, and/or the user interface generation circuitry 260 can be implemented in or with at least one of the GPU 1642, the VPU 1644, or the neural network processor 1646 instead of or in addition to the processor circuitry 1612.

FIG. 17 is a block diagram of an example processor platform 1700 structured to execute and/or instantiate the machine readable instructions and/or the operations of FIGS. 9-15 to implement the device configuration agent circuitry 300 of FIG. 3. The processor platform 1700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1700 of the illustrated example includes processor circuitry 1712. The processor circuitry 1712 of the illustrated example is hardware. For example, the processor circuitry 1712 can be implemented by one or more integrated circuits, logic circuits, FPGAs, microprocessors, CPUs, GPUs, DSPs, and/or microcontrollers from any desired family or manufacturer. The processor circuitry 1712 may be implemented by one or more semiconductor based (e.g., silicon based) devices. In this example, the processor circuitry 1712 implements the discover device circuitry 320, the device connection circuitry 330 (identified by DEVICE CXN CIRCUITRY), the data aggregation circuitry 340 (identified by DATA AGGREGATE CIRCUITRY), the user interface generation circuitry 350 (identified by UI GENERATION CIRCUITRY), and the container execution circuitry 360 of FIG. 3.

The processor circuitry 1712 of the illustrated example includes a local memory 1713 (e.g., a cache, registers, etc.). The processor circuitry 1712 of the illustrated example is in communication with a main memory including a volatile memory 1714 and a non-volatile memory 1716 by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717.

The processor platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1720 implements the network interface circuitry 310 (identified by NETWORK I/F CIRCUITRY) of FIG. 3.

In the illustrated example, one or more input devices 1722 are connected to the interface circuitry 1720. The input device(s) 1722 permit(s) a user to enter data and/or commands into the processor circuitry 1712. The input device(s) 1722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1724 are also connected to the interface circuitry 1720 of the illustrated example. The output device(s) 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1700 of the illustrated example also includes one or more mass storage devices 1728 to store software and/or data. Examples of such mass storage devices 1728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 1728 implement the datastore 370, the telemetry data 372, the URI(s) 374, and the container(s) 376 of FIG. 3.

The machine readable instructions 1732, which may be implemented by the machine readable instructions of FIGS. 9-15, may be stored in the mass storage device 1728, in the volatile memory 1714, in the non-volatile memory 1716, and/or on a removable non-transitory computer readable storage medium such as a CD or DVD.

FIG. 18 is a block diagram of an example implementation of the processor circuitry 1612 of FIG. 16 and/or the processor circuitry 1712 of FIG. 17. In this example, the processor circuitry 1612 of FIG. 16 and/or the processor circuitry 1712 of FIG. 17 is implemented by a microprocessor 1800. For example, the microprocessor 1800 may be a general purpose microprocessor (e.g., general purpose microprocessor circuitry). The microprocessor 1800 executes some or all of the machine readable instructions of the flowcharts of FIGS. 9-15 to effectively instantiate the device configuration agent interface circuitry 200 of FIG. 2 and/or the device configuration agent circuitry 300 of FIG. 3 as logic circuits to perform the operations corresponding to those machine readable instructions. In some such examples, the device configuration agent interface circuitry 200 of FIG. 2 and/or the device configuration agent circuitry 300 of FIG. 3 is/are instantiated by the hardware circuits of the microprocessor 1800 in combination with the instructions. For example, the microprocessor 1800 may be implemented by multi-core hardware circuitry such as a CPU, a DSP, a GPU, an XPU, etc. Although it may include any number of example cores 1802 (e.g., 1 core), the microprocessor 1800 of this example is a multi-core semiconductor device including N cores. The cores 1802 of the microprocessor 1800 may operate independently or may cooperate to execute machine readable instructions. For example, machine code corresponding to a firmware program, an embedded software program, or a software program may be executed by one of the cores 1802 or may be executed by multiple ones of the cores 1802 at the same or different times. In some examples, the machine code corresponding to the firmware program, the embedded software program, or the software program is split into threads and executed in parallel by two or more of the cores 1802. The software program may correspond to a portion or all of the machine readable instructions and/or operations represented by the flowcharts of FIGS. 9-15.

The cores 1802 may communicate by a first example bus 1804. In some examples, the first bus 1804 may be implemented by a communication bus to effectuate communication associated with one(s) of the cores 1802. For example, the first bus 1804 may be implemented by at least one of an Inter-Integrated Circuit (I2C) bus, a Serial Peripheral Interface (SPI) bus, a PCI bus, or a PCIe bus. Additionally or alternatively, the first bus 1804 may be implemented by any other type of computing or electrical bus. The cores 1802 may obtain data, instructions, and/or signals from one or more external devices by example interface circuitry 1806. The cores 1802 may output data, instructions, and/or signals to the one or more external devices by the interface circuitry 1806. Although the cores 1802 of this example include example local memory 1820 (e.g., Level 1 (L1) cache that may be split into an L1 data cache and an L1 instruction cache), the microprocessor 1800 also includes example shared memory 1810 that may be shared by the cores (e.g., Level 2 (L2 cache)) for high-speed access to data and/or instructions. Data and/or instructions may be transferred (e.g., shared) by writing to and/or reading from the shared memory 1810. The local memory 1820 of each of the cores 1802 and the shared memory 1810 may be part of a hierarchy of storage devices including multiple levels of cache memory and the main memory (e.g., the main memory 1614, 1616 of FIG. 16 and/or the main memory 1714, 1716 of FIG. 17). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1802 may be referred to as a CPU, DSP, GPU, etc., or any other type of hardware circuitry. Each core 1802 includes control unit circuitry 1814, arithmetic and logic (AL) circuitry (sometimes referred to as an ALU) 1816, a plurality of registers 1818, the local memory 1820, and a second example bus 1822. Other structures may be present. For example, each core 1802 may include vector unit circuitry, single instruction multiple data (SIMD) unit circuitry, load/store unit (LSU) circuitry, branch/jump unit circuitry, floating-point unit (FPU) circuitry, etc. The control unit circuitry 1814 includes semiconductor-based circuits structured to control (e.g., coordinate) data movement within the corresponding core 1802. The AL circuitry 1816 includes semiconductor-based circuits structured to perform one or more mathematic and/or logic operations on the data within the corresponding core 1802. The AL circuitry 1816 of some examples performs integer based operations. In other examples, the AL circuitry 1816 also performs floating point operations. In yet other examples, the AL circuitry 1816 may include first AL circuitry that performs integer based operations and second AL circuitry that performs floating point operations. In some examples, the AL circuitry 1816 may be referred to as an Arithmetic Logic Unit (ALU). The registers 1818 are semiconductor-based structures to store data and/or instructions such as results of one or more of the operations performed by the AL circuitry 1816 of the corresponding core 1802. For example, the registers 1818 may include vector register(s), SIMD register(s), general purpose register(s), flag register(s), segment register(s), machine specific register(s), instruction pointer register(s), control register(s), debug register(s), memory management register(s), machine check register(s), etc. The registers 1818 may be arranged in a bank as shown in FIG. 18. Alternatively, the registers 1818 may be organized in any other arrangement, format, or structure including distributed throughout the core 1802 to shorten access time. The second bus 1822 may be implemented by at least one of an I2C bus, a SPI bus, a PCI bus, or a PCIe bus

Each core 1802 and/or, more generally, the microprocessor 1800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 19 is a block diagram of another example implementation of the processor circuitry 1612 of FIG. 16 and/or the processor circuitry 1712 of FIG. 17. In this example, the processor circuitry 1612 of FIG. 16 and/or the processor circuitry 1712 of FIG. 17 is/are implemented by FPGA circuitry 1900. For example, the FPGA circuitry 1900 may be implemented by an FPGA. The FPGA circuitry 1900 can be used, for example, to perform operations that could otherwise be performed by the example microprocessor 1800 of FIG. 18 executing corresponding machine readable instructions. However, once configured, the FPGA circuitry 1900 instantiates the machine readable instructions in hardware and, thus, can often execute the operations faster than they could be performed by a general purpose microprocessor executing the corresponding software.

More specifically, in contrast to the microprocessor 1800 of FIG. 18 described above (which is a general purpose device that may be programmed to execute some or all of the machine readable instructions represented by the flowcharts of FIGS. 9-15 but whose interconnections and logic circuitry are fixed once fabricated), the FPGA circuitry 1900 of the example of FIG. 19 includes interconnections and logic circuitry that may be configured and/or interconnected in different ways after fabrication to instantiate, for example, some or all of the machine readable instructions represented by the flowcharts of FIGS. 9-15. In particular, the FPGA circuitry 1900 may be thought of as an array of logic gates, interconnections, and switches. The switches can be programmed to change how the logic gates are interconnected by the interconnections, effectively forming one or more dedicated logic circuits (unless and until the FPGA circuitry 1900 is reprogrammed). The configured logic circuits enable the logic gates to cooperate in different ways to perform different operations on data received by input circuitry. Those operations may correspond to some or all of the software represented by the flowcharts of FIGS. 9-15. As such, the FPGA circuitry 1900 may be structured to effectively instantiate some or all of the machine readable instructions of the flowcharts of FIGS. 9-15 as dedicated logic circuits to perform the operations corresponding to those software instructions in a dedicated manner analogous to an ASIC. Therefore, the FPGA circuitry 1900 may perform the operations corresponding to the some or all of the machine readable instructions of FIGS. 9-15 faster than the general purpose microprocessor can execute the same.

In the example of FIG. 19, the FPGA circuitry 1900 is structured to be programmed (and/or reprogrammed one or more times) by an end user by a hardware description language (HDL) such as Verilog. The FPGA circuitry 1900 of FIG. 19, includes example input/output (I/O) circuitry 1902 to obtain and/or output data to/from example configuration circuitry 1904 and/or external hardware 1906. For example, the configuration circuitry 1904 may be implemented by interface circuitry that may obtain machine readable instructions to configure the FPGA circuitry 1900, or portion(s) thereof. In some such examples, the configuration circuitry 1904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1906 may be implemented by external hardware circuitry. For example, the external hardware 1906 may be implemented by the microprocessor 1800 of FIG. 18. The FPGA circuitry 1900 also includes an array of example logic gate circuitry 1908, a plurality of example configurable interconnections 1910, and example storage circuitry 1912. The logic gate circuitry 1908 and the configurable interconnections 1910 are configurable to instantiate one or more operations that may correspond to at least some of the machine readable instructions of FIGS. 9-15 and/or other desired operations. The logic gate circuitry 1908 shown in FIG. 19 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1908 to enable configuration of the electrical structures and/or the logic gates to form circuits to perform desired operations. The logic gate circuitry 1908 may include other electrical structures such as look-up tables (LUTs), registers (e.g., flip-flops or latches), multiplexers, etc.

The configurable interconnections 1910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1908 to program desired logic circuits.

The storage circuitry 1912 of the illustrated example is structured to store result(s) of the one or more of the operations performed by corresponding logic gates. The storage circuitry 1912 may be implemented by registers or the like. In the illustrated example, the storage circuitry 1912 is distributed amongst the logic gate circuitry 1908 to facilitate access and increase execution speed.

The example FPGA circuitry 1900 of FIG. 19 also includes example Dedicated Operations Circuitry 1914. In this example, the Dedicated Operations Circuitry 1914 includes special purpose circuitry 1916 that may be invoked to implement commonly used functions to avoid the need to program those functions in the field. Examples of such special purpose circuitry 1916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1900 may also include example general purpose programmable circuitry 1918 such as an example CPU 1920 and/or an example DSP 1922. Other general purpose programmable circuitry 1918 may additionally or alternatively be present such as a GPU, an XPU, etc., that can be programmed to perform other operations.

Although FIGS. 18 and 19 illustrate two example implementations of the processor circuitry 1612 of FIG. 16 and/or the processor circuitry 1712 of FIG. 17, many other approaches are contemplated. For example, as mentioned above, modern FPGA circuitry may include an on-board CPU, such as one or more of the example CPU 1920 of FIG. 19. Therefore, the processor circuitry 1612 of FIG. 16 and/or the processor circuitry 1712 of FIG. 17 may additionally be implemented by combining the example microprocessor 1800 of FIG. 18 and the example FPGA circuitry 1900 of FIG. 19. In some such hybrid examples, a first portion of the machine readable instructions represented by the flowcharts of FIGS. 9-15 may be executed by one or more of the cores 1802 of FIG. 18, a second portion of the machine readable instructions represented by the flowcharts of FIGS. 9-15 may be executed by the FPGA circuitry 1900 of FIG. 19, and/or a third portion of the machine readable instructions represented by the flowcharts of FIGS. 0-15 may be executed by an ASIC. It should be understood that some or all of the device configuration agent interface circuitry 200 of FIG. 2 and/or the device configuration agent circuitry 300 of FIG. 3 may, thus, be instantiated at the same or different times. Some or all of the circuitry may be instantiated, for example, in one or more threads executing concurrently and/or in series. Moreover, in some examples, some or all of the device configuration agent interface circuitry 200 of FIG. 2 and/or the device configuration agent circuitry 300 of FIG. 3 may be implemented within one or more virtual machines and/or containers executing on the microprocessor.

In some examples, the processor circuitry 1612 of FIG. 16 and/or the processor circuitry 1712 of FIG. 17 may be in one or more packages. For example, the microprocessor 1800 of FIG. 18 and/or the FPGA circuitry 1900 of FIG. 19 may be in one or more packages. In some examples, an XPU may be implemented by the processor circuitry 1612 of FIG. 16 and/or the processor circuitry 1712 of FIG. 17, which may be in one or more packages. For example, the XPU may include a CPU in one package, a DSP in another package, a GPU in yet another package, and an FPGA in still yet another package.

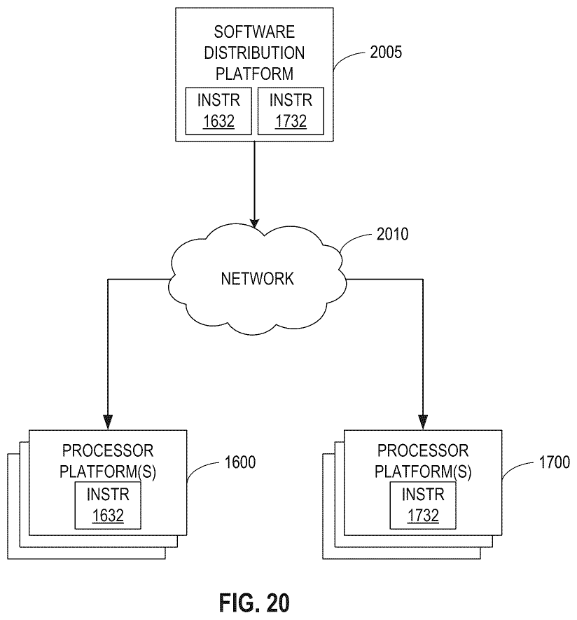

A block diagram illustrating an example software distribution platform 2005 to distribute software such as the example machine readable instructions 1632 of FIG. 16 and/or the example machine readable instructions 1732 of FIG. 17 to hardware devices owned and/or operated by third parties is illustrated in FIG. 20. The example software distribution platform 2005 may be implemented by any computer server, data facility, cloud service, etc., capable of storing and transmitting software to other computing devices. The third parties may be customers of the entity owning and/or operating the software distribution platform 2005. For example, the entity that owns and/or operates the software distribution platform 2005 may be a developer, a seller, and/or a licensor of software such as the example machine readable instructions 1632 of FIG. 16 and/or the example machine-readable instructions 1732 of FIG. 17. The third parties may be consumers, users, retailers, OEMs, etc., who purchase and/or license the software for use and/or re-sale and/or sub-licensing. In the illustrated example, the software distribution platform 2005 includes one or more servers and one or more storage devices. The storage devices store the machine readable instructions 1632, 1732, which may correspond to the example machine readable instructions 900, 1000, 1100, 1200, 1300, 1400, 1500 of FIGS. 9-15, as described above. The one or more servers of the example software distribution platform 2005 are in communication with an example network 2010, which may correspond to any one or more of the Internet and/or any of the example networks 124, 1626, 1726 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1632, 1732 from the software distribution platform 2005. For example, the software, which may correspond to the example machine readable instructions 900, 1000, 1100, 1200, 1300, 1400, 1500 of FIGS. 9-15, may be downloaded to the example processor platform 1600, which is to execute the machine readable instructions 1632 to implement the device configuration agent interface circuitry 200. In some examples, the software, which may correspond to the example machine readable instructions 900, 1000, 1100, 1200, 1300, 1400, 1500 of FIGS. 9-15, may be downloaded to the example processor platform 1700, which is to execute the machine readable instructions 1732 to implement the device configuration agent circuitry 300. In some examples, one or more servers of the software distribution platform 2005 periodically offer, transmit, and/or force updates to the software (e.g., the example machine readable instructions 1632 of FIG. 16 and/or the example machine readable instructions 1732 of FIG. 17) to ensure improvements, patches, updates, etc., are distributed and applied to the software at the end user devices.

From the foregoing, it will be appreciated that example systems, methods, apparatus, and articles of manufacture have been disclosed that improve device connectivity. Disclosed systems, methods, apparatus, and articles of manufacture improve the efficiency of using a computing and/or electronic device by effectuating relatively easy user experiences with connecting devices together that may originate from different hardware and/or software manufacturers, vendors, or developers. For example, requiring a fewer number of clicks to connect to a device correspondingly requires a fewer number of hardware and/or software resources needed to effectuate the device connection(s). By requiring a fewer number of hardware and/or software resources, a machine such as a computer or other electronic and/or mechanical device can execute additional workloads or computing tasks, can store less information (e.g., less machine-readable instructions, DLLs, services, executables, etc.) than in prior implementations, etc. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to improve device connectivity are disclosed herein. Further examples and combinations thereof include the following:

Example 1 includes a system to improve device connectivity, the system comprising an endpoint device to, after obtaining the message, launch a user interface to display a request for authorization to connect to the electronic device, after obtaining the authorization, retrieve an instance of a container based on the URI, and execute a service with the container based on data obtained from the electronic device.

Example 2 includes the system of example 1, wherein the electronic device broadcasts the message upon bootup of the electronic device.

Example 3 includes the system of example 1, wherein the electronic device is a first electronic device, and the system further including a second electronic device to capture an image of a code associated with the first electronic device, determine that the code is representative of the URI, trigger an application based on the URI to discover the endpoint device, and transmit the URI to the endpoint device.

Example 4 includes the system of example 1, wherein the electronic device broadcasts the message after obtaining an input signal representative of a manual pairing operation.

Example 5 includes the system of example 1, wherein the endpoint device captures an image of a code associated with the electronic device, determines that the code is representative of the URI, and generates the user interface based on the URI.

Example 6 includes the system of example 1, wherein the electronic device is a first electronic device, the data is first data, the service is a machine-learning service, and the endpoint device executes the machine-learning service on the first data and second data from a second electronic device to generate a machine-learning output, and generates a recommendation based on the machine-learning output, the recommendation to be representative of an operation to be performed by at least one of the first electronic device or the second electronic device.

Example 7 includes the system of example 1, further including a server to generate the URI to correspond to the electronic device, append a data wrapper to the URI to generate an encapsulated URI, generate a data association of the encapsulated URI and the container, and cause transmission of the container to the endpoint device after (a) obtaining the encapsulated URI from the endpoint device and (b) identifying the container based on the data association.

Example 8 includes an apparatus to improve device connectivity, the apparatus comprising at least one memory, machine readable instructions, and processor circuitry to at least one of instantiate or execute the machine readable instructions to connect to an electronic device based on a uniform resource indicator (URI) obtained from the electronic device, and after obtaining a container from a server based on the URI, instantiate the container to execute a workload associated with the electronic device.

Example 9 includes the apparatus of example 8, wherein the processor circuitry launches a user interface to display a notification representative of a request for authorization to connect to the electronic device, and obtains an authorization via the user interface to connect to the electronic device.

Example 10 includes the apparatus of example 8, wherein the processor circuitry obtains an image of a code associated with the electronic device, and identifies the URI based on the code.

Example 11 includes the apparatus of example 10, wherein the code is a quick response code.

Example 12 includes the apparatus of example 8, wherein the processor circuitry obtains data from a near-field communication device associated with the electronic device, and identifies the URI based on the data.

Example 13 includes the apparatus of example 8, wherein the processor circuitry obtains data from a radiofrequency identification tag associated with the electronic device, and identifies the URI based on the data.

Example 14 includes the apparatus of example 8, wherein the apparatus is a first endpoint device, and the processor circuitry obtains a request to connect the electronic device to the first endpoint device and a second endpoint device, establishes a mesh network including the first endpoint device and the second endpoint device, and causes transmission of data from the electronic device to the second endpoint device via the mesh network.

Example 15 includes the apparatus of example 8, wherein the processor circuitry instantiates the container to execute a machine-learning model on the workload.

Example 16 includes the apparatus of example 8, wherein the electronic device is a first electronic device, and the processor circuitry obtains first data from the first electronic device and second data from a second electronic device, selects at least one of a first portion of the first data or a second portion of the second data, and executes the workload based on the at least one of the first portion or the second portion.

Example 17 includes at least one non-transitory machine readable storage medium comprising instructions that, when executed, cause processor circuitry to at least connect to an electronic device based on a uniform resource indicator (URI) obtained from the electronic device, and after obtaining a container from a server based on the URI, instantiate the container to execute a workload associated with the electronic device.

Example 18 includes the at least one non-transitory machine readable storage medium of example 17, wherein the instructions are to cause the processor circuitry to launch a user interface to display a notification representative of a request for authorization to connect to the electronic device, and obtain an authorization via the user interface to connect to the electronic device.

Example 19 includes the at least one non-transitory machine readable storage medium of example 17, wherein the instructions are to cause the processor circuitry to obtain an image of a code associated with the electronic device, and identify the URI based on the code.

Example 20 includes the at least one non-transitory machine readable storage medium of example 19, wherein the instructions are to cause the processor circuitry to determine that the code is a quick response code.

Example 21 includes the at least one non-transitory machine readable storage medium of example 17, wherein the instructions are to cause the processor circuitry to obtain data from a near-field communication device associated with the electronic device, and identify the URI based on the data.

Example 22 includes the at least one non-transitory machine readable storage medium of example 17, wherein the instructions are to cause the processor circuitry to obtain data from a radiofrequency identification tag associated with the electronic device, and identify the URI based on the data.

Example 23 includes the at least one non-transitory machine readable storage medium of example 17, wherein the instructions are to cause the processor circuitry to obtain a request to connect the electronic device to a first endpoint device and a second endpoint device, establish a mesh network including the first endpoint device and the second endpoint device, and cause transmission of data from the electronic device to the second endpoint device via the mesh network.

Example 24 includes the at least one non-transitory machine readable storage medium of example 17, wherein the instructions are to cause the processor circuitry to instantiate the container to execute a machine-learning model on the workload.

Example 25 includes the at least one non-transitory machine readable storage medium of example 17, wherein the electronic device is a first electronic device, and the instructions are to cause the processor circuitry to obtain first data from the first electronic device and second data from a second electronic device, select at least one of a first portion of the first data or a second portion of the second data, and execute the workload based on the at least one of the first portion or the second portion.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A system to improve device connectivity, the system comprising:
an electronic device to broadcast a message including a uniform resource indicator (URI), the URI corresponding to the electronic device; and
an endpoint device to:
after obtaining the message, launch a user interface to display a request for authorization to connect to the electronic device;
after obtaining the authorization, retrieve an instance of a container based on the URI; and
execute a service with the container based on data obtained from the electronic device.

2. The system of claim 1, wherein the electronic device broadcasts the message upon bootup of the electronic device.

3. The system of claim 1, wherein the electronic device is a first electronic device, and the system further including a second electronic device to:
capture an image of a code associated with the first electronic device;
determine that the code is representative of the URI;
trigger an application based on the URI to discover the endpoint device; and
transmit the URI to the endpoint device.

4. The system of claim 1, wherein the electronic device broadcasts the message after obtaining an input signal representative of a manual pairing operation.

5. The system of claim 1, wherein the endpoint device:
captures an image of a code associated with the electronic device;
determines that the code is representative of the URI; and
generates the user interface based on the URI.

6. The system of claim 1, wherein the electronic device is a first electronic device, the data is first data, the service is a machine-learning service, and the endpoint device:
executes the machine-learning service on the first data and second data from a second electronic device to generate a machine-learning output; and
generates a recommendation based on the machine-learning output, the recommendation to be representative of an operation to be performed by at least one of the first electronic device or the second electronic device.

7. The system of claim 1, further including a server to:
generate the URI to correspond to the electronic device;
append a data wrapper to the URI to generate an encapsulated URI;
generate a data association of the encapsulated URI and the container; and
cause transmission of the container to the endpoint device after (a) obtaining the encapsulated URI from the endpoint device and (b) identifying the container based on the data association.

8. An apparatus to improve device connectivity, the apparatus comprising:
at least one memory;
machine readable instructions; and
processor circuitry to at least one of instantiate or execute the machine readable instructions to:
connect to an electronic device based on a uniform resource indicator (URI) obtained from the electronic device; and
after obtaining a container from a server based on the URI, instantiate the container to execute a workload associated with the electronic device.

9. The apparatus of claim 8, wherein the processor circuitry:
launches a user interface to display a notification representative of a request for authorization to connect to the electronic device; and
obtains an authorization via the user interface to connect to the electronic device.

10. The apparatus of claim 8, wherein the processor circuitry:
obtains an image of a code associated with the electronic device; and
identifies the URI based on the code.

11. The apparatus of claim 10, wherein the code is a quick response code.

12. The apparatus of claim 8, wherein the processor circuitry:
obtains data from a near-field communication device associated with the electronic device; and
identifies the URI based on the data.

13. The apparatus of claim 8, wherein the processor circuitry:
obtains data from a radiofrequency identification tag associated with the electronic device; and
identifies the URI based on the data.

14. The apparatus of claim 8, wherein the apparatus is a first endpoint device, and the processor circuitry:
obtains a request to connect the electronic device to the first endpoint device and a second endpoint device;
establishes a mesh network including the first endpoint device and the second endpoint device; and
causes transmission of data from the electronic device to the second endpoint device via the mesh network.

15. The apparatus of claim 8, wherein the processor circuitry instantiates the container to execute a machine-learning model on the workload.

16. The apparatus of claim 8, wherein the electronic device is a first electronic device, and the processor circuitry:
obtains first data from the first electronic device and second data from a second electronic device;
selects at least one of a first portion of the first data or a second portion of the second data; and
executes the workload based on the at least one of the first portion or the second portion.

17. At least one non-transitory machine readable storage medium comprising instructions that, when executed, cause processor circuitry to at least:
connect to an electronic device based on a uniform resource indicator (URI) obtained from the electronic device; and
after obtaining a container from a server based on the URI, instantiate the container to execute a workload associated with the electronic device.

18. The at least one non-transitory machine readable storage medium of claim 17, wherein the instructions are to cause the processor circuitry to:
launch a user interface to display a notification representative of a request for authorization to connect to the electronic device; and
obtain an authorization via the user interface to connect to the electronic device.

19. The at least one non-transitory machine readable storage medium of claim 17, wherein the instructions are to cause the processor circuitry to:
obtain an image of a code associated with the electronic device; and
identify the URI based on the code.

20. The at least one non-transitory machine readable storage medium of claim 19, wherein the instructions are to cause the processor circuitry to determine that the code is a quick response code.

21. The at least one non-transitory machine readable storage medium of claim 17, wherein the instructions are to cause the processor circuitry to:
obtain data from a near-field communication device associated with the electronic device; and
identify the URI based on the data.

22. The at least one non-transitory machine readable storage medium of claim 17, wherein the instructions are to cause the processor circuitry to:
obtain data from a radiofrequency identification tag associated with the electronic device; and
identify the URI based on the data.

23. The at least one non-transitory machine readable storage medium of claim 17, wherein the instructions are to cause the processor circuitry to:
obtain a request to connect the electronic device to a first endpoint device and a second endpoint device;
establish a mesh network including the first endpoint device and the second endpoint device; and
cause transmission of data from the electronic device to the second endpoint device via the mesh network.

24. The at least one non-transitory machine readable storage medium of claim 17, wherein the instructions are to cause the processor circuitry to instantiate the container to execute a machine-learning model on the workload.

25. The at least one non-transitory machine readable storage medium of claim 17, wherein the electronic device is a first electronic device, and the instructions are to cause the processor circuitry to:
obtain first data from the first electronic device and second data from a second electronic device;
select at least one of a first portion of the first data or a second portion of the second data; and
execute the workload based on the at least one of the first portion or the second portion.
